(19) United States
(12) Patent Application Publication
(10) Pub. No.: US 2020/0287880 A1
(43) Pub. Date: Sep. 10, 2020

(54) DATA ENCRYPTION

(71) Applicant: ALLTANA, INC., AUSTIN, TX (US)

(72) Inventors: EUGENIY GETSIN, SAN RAFAEL, CA (US); DIPAK CHOCHA, BREA, CA (US); CARY CAPECE, AUSTIN, TX (US); PAVANKANTH MUKTHINUTHALAPATI, DUBLIN, CA (US); OLEH BONDARENKO, PLEASANT HILL, CA (US)

(21) Appl. No.: 16/812,115

(22) Filed: Mar. 6, 2020

Related U.S. Application Data
(60) Provisional application No. 62/815,905, filed on Mar. 8, 2019.

(51) Int. Cl. H04L 29/06; H04L 9/06; G06F 16/901

(52) U.S. Cl. CPC H04L 63/06; H04L 63/0442; H04L 2209/38; H04L 9/0643; G06F 16/9014; H04L 9/0637

(57) ABSTRACT

Systems and methods for data distribution based on encryption are described. Embodiments of the systems and methods may include a first computer system comprising a first storage system that has a first input directory and a first virtual read directory, the first computer system further comprising a first file system comprising a first encryption system for encrypting a data file stored to the first input directory upon access of the data file from the first virtual read directory, a data communications network for communicating the data file having been encrypted from the first computer system, and a second computer system coupled to the data communications network for receiving the data file from the data communications network, the second computer system further comprising a second encryption system for decrypting the data file.

This application claims the benefit of U.S. Provisional Application No. 62/815,905, filed Mar. 8, 2019, for SYSTEM AND METHOD FOR SECURE ACCESS CONTROL TO DIGITAL CONTENT, which is incorporated in its entirety herein by reference.

### BACKGROUND OF THE INVENTION

### 1. Field of the Invention

The present invention relates generally to data distribution, and more specifically to data distribution based on encryption.

### 2. Discussion of the Related Art

Various systems and processes are known in the art for encrypted data distribution based on encryption. For example, data may be distributed over a protected or encrypted tunnel such as a Secure Sockets Layer (SSL), Transport Layer Security (TLS), Hypertext Transfer Protocol Secure (HTTPS), SFTP (SSH File Transfer Protocol), or a Virtual Private Network (VPN). These channels allow for a secure connection or pipe. However, the content itself is not encrypted.

Another method, which can be used separately or in addition to a protected channel, includes encryption of the file at its source and then transmitted to a receiving device where the receiving device is opening the content requests for a password or the decryption key for playback and access. This method is prevalent in protected video playback or when using protected files such as protected Word, Excel or Zip files, or other protected formats. Another form of protection is encryption at rest which while the files are stored on a disk they are encrypted however as soon as they are read they are decrypted.

However, conventional data distribution methods do not provide access control in a way that is transparent to application using the data. Therefore, there is a need in the art for systems and methods to control access to content over time, at a file access level, that is transparent to the application reading the content from a storage device.

### SUMMARY

A system and method for data distribution based on encryption are described. Embodiments of the system and method may include a first computer system comprising a first storage system comprising a first input directory and a first virtual read directory, the first computer system further comprising a first file system comprising a first encryption system for encrypting a data file stored to the first input directory upon access of the data file from the first virtual read directory, a data communications network for communicating the data file having been encrypted from the first computer system, and a second computer system coupled to the data communications network for receiving the data file from the data communications network, the second computer system further comprising a second encryption system for decrypting the data file.

A method, apparatus, and non-transitory computer readable medium for data distribution based on encryption are described. Embodiments of the method, apparatus, and non-transitory computer readable medium may access a data file from a first virtual read directory, encrypt a data file stored to a first input directory, transmit the encrypted data file across a data communications network, receive the encrypted data file, and decrypt the encrypted data file.

### BRIEF DESCRIPTION OF THE DRAWINGS

FIG. 1 shows an example of information relevant to a system for data distribution according to aspects of the present disclosure.

FIG. 2 shows an example of a subscription model according to aspects of the present disclosure.

FIG. 3 shows an example of an administrative user interface according to aspects of the present disclosure.

FIG. 4 shows an example of a user interface according to aspects of the present disclosure.

FIG. 5 shows an example of a data flow according to aspects of the present disclosure.

FIG. 6 shows an example of a secondary data flow according to aspects of the present disclosure.

FIG. 7 shows an example of a system for data distribution according to aspects of the present disclosure.

FIG. 8 shows an example of an overview of a data distribution process according to aspects of the present disclosure.

FIG. 9 shows an example of a data distribution process according to aspects of the present disclosure.

FIG. 10 shows an example of an access tree according to aspects of the present disclosure.

FIG. 11 shows an example of a user interface with package statistics according to aspects of the present disclosure.

FIG. 12 shows an example of a data distribution process according to aspects of the present disclosure.

FIG. 13 shows an example of a system for data distribution according to aspects of the present disclosure.

FIG. 14 shows an example of an account creation process for according to aspects of the present disclosure.

FIGS. 15A and 15B show an example of a process for dropping a file to a fuse drive according to aspects of the present disclosure.

FIGS. 16A, 16B, 16C and 16D show an example of a process for downloading a file according to aspects of the present disclosure.

FIG. 17 shows an example of a process for uploading a file according to aspects of the present disclosure.

FIG. 18 shows an example of a file administration system according to aspects of the present disclosure.

FIG. 19 shows an example of a file administration system according to aspects of the present disclosure.

FIG. 20 shows an example of a subscription management interface according to aspects of the present disclosure.

FIGS. 21 and 22 show an example of a workgroup interface according to aspects of the present disclosure.

FIG. 23 shows an example of a system for distributing encrypted data files according to aspects of the present disclosure.

FIGS. 24 through 27 show examples of a process for data distribution based on encryption according to aspects of the present disclosure.

### DETAILED DESCRIPTION

The present disclosure relates to encrypted data distribution. In some cases, data is distributed over a protected or encrypted channel. Another method, which can be used separately or in addition to a protected channel, includes encryption of the file at its source and then transmitted to a receiving device where the receiving device is opening the content requests for a password or the decryption key for playback and access.

However, conventional data distribution methods do not provide access control in a way that is transparent to application using the data. Therefore, the present disclosure describes systems and methods to control access to content over time, at a file access level, that is transparent to the application reading the content from a storage device.

According to various embodiments, file access rights can be tied to a device or a user along with restricting what applications or processes are allowed to access the file. These rights can further be authorized or revoked based on various criteria, including an organization user ID, a device ID, a time frame given a start or end date, number of file times a file has been accessed, etc. File access and distribution may be tracked and stored for future auditing and tracking in a blockchain or database to track the file history. With this audit trail, embodiments of the present disclosure may show not only when a file has been received at its destination, but also when it has been accessed by a processing application by a given user on a given device and it is being processed.

Embodiments of the service provides end to end secure file delivery and distribution across any device, utilizing any transfer methodology available on the market. Embodiments of the service include a variety of desktop applications and key-based delivery systems, where keys are being stored in a native cloud format, AWS key storage or Azure key management system. Embodiments of the service protects files with Key Management system policies and designated users. Embodiments of the service may deliver large media or other types of files with integrated access control and 3-party verification services, for example, a ledger in the private blockchain.

Blockchain services may enable creation of an audit trail between organizations to demonstrate and prove content delivery and content transformation. Embodiments of the service can integrate with existing transfer technology and various supply chains. Embodiments of the service tracks file activity, tracks file access and movement, and provides logging and verified ledger.

Various embodiments of the present disclosure may include the following features: transparent file writes of a source unencrypted file to a directory and then reading back out from another directory the same file that is an encrypted file as it is read out; native acceleration, streaming and adding the encryption/decryption during file transfer; transparent writing of an encrypted file to a directory and upon reading back the file from another directory it is unencrypted file and delivered; using a Checksum of a file to lookup in a database to determine the encryption key to use with the associated file; and an encryption system where the rights to access an encrypted file include only allowing decryption to occur on read when the read is from a specific application allowed to access a file that is on a whitelist.

Various embodiments may also include: enabling access for a specific user through credentials to access a file; file access or denial determined by whitelist/blacklists of Machine IDs to access a file, during a specific time frame, such as an elapsed time from when the file was last accessed; tracking an encrypted file and reporting when it has been accessed by a processing application by a given user and is being processed; and verification of the integrity of a file during the read process and simultaneously computing the hash on the encrypted file as it is read and the decrypted file as it is being decoded.

In one embodiment for integration with Aspera the files are seen as a collection of files in a session. For each to work properly there may be enough file I/O and low latency. Sometimes it goes against a single node on a server, which may not have enough capacity. In an implementation of the client delivery application, it can measure the rate current files are being uploaded and decide on which server endpoint to deliver the next file or segment based on the actual speed or append the session or switch over to read from a different server to pull the rest of the file from. This delivery can be performed in parallel from multiple servers as well. This can work in encryption and decryption scenarios.

In an example application of the systems and methods described herein, a file distribution system may be used for the distribution of music or other media. This may enable tracking of assets throughout an entire distribution workflow (i.e., high visibility). A file distribution system may track assets within a content provider (CP); provide visibility: across one or more vendors (post, production houses, localization, etc.), including visibility across multiple vendor facilities and individuals within such facility; with vendor subcontractors (especially important for localization) that are also receiving/using an asset on behalf of a vendor (and therefore content provider); and to content provider licensee (receipt) of the finished asset (examples: cinema, cable/telco, OTT service provider, etc.)

A file distribution system may also enable controlled distribution. For example, a system may enable the ability to: release content based on time/date and time window restrictions; control release/distribution to each specific organization; control release/distribution to specific individuals within an organization or vendor (which is especially important for pre-theatrical/high-value content); and control the distribution by a subcontractor on their behalf to other subcontractors or distributors.

A file distribution system may also enable controlled access. For example, the system may track users, groups and organizations for an account. Accounts may support multiple organizations. The system may also control which employees have access to a given set of files and with which applications or, enable the timed release of media. In some cases, a timed release may be specific to a distribution on a particular medium such as Facebook, Twitter, Instagram, etc. In some examples, this depends on an interim mezzanine file format to feed licensee workflows; may even require finished/transcoded ABRs.

A file distribution system may also white or black-list, including the ability to white-list and black-list specific organizations, users, applications that can open content (on title/version-specific level).

A file distribution system may also enable vendor management. For example, a system may: track, audit, and report on the distribution of work to vendors (if you are the rights holder); track what % of work is going to which vendors (by title); track, audit, and report on which vendors have which files (file lineage tracking); or track throughput of vendor/service providers (when received; when work was started (accessed file) to when work was completed). Metrics may be tied into a tracking dashboard to view all vendors/licensees.

A file distribution system may also automate version control, including disabling of older files once a new file is made available. Could also be used to track the file versioning process, and allow a vendor to check and determine what the latest file is, or what files are old and no longer needed. In some cases, a system may utilize certificates of destruction. The system may also enable the ability to revoke rights to content in a field if invalid version is detected (e.g., if file is sent to the incorrect location).

A certificate of destruction is a process whereby a media owner informs a license to destroy an asset. A file distribution system may enable a content provider to define and implement the destruction of assets delivered to one or more licensees with automated disabling of files. In some cases, the system provides the ability to audit a certificate of destruction. In some cases, an application may have the ability to track any attempted use by a vendor of an asset for which vendor has received notice of destruction.

Example embodiments can secure applications to work with files without ever having a copy in the clear. The application will stream the content from the disk directly to the requestor application. An application can incrementally offer watermarking capability (for internal workflows/tracking, especially when assets get into the clear), or for downstream tracking (after production workflows and all the way into D2C scenarios). Watermarking can be applied while the asset is decrypted to serve the bytes to an application. We can use user's personal information for the watermarking or a device ID or other personally identifiable means.

Example embodiments can provide varying levels of control, access, and visibility to content providers. This includes reports to see the traversal of the data from organization to organization and also within the organization. A report to review the overall vendor performance to show response times and processing times. This includes the time from receipt of the file to processing actually begins and when the file has been accessed. Further risk exposure can be evaluated by showing how many individuals have accessed the file, and how many individuals have actually accessed the file and from what devices.

Example embodiments can also provide the ability for checking for duplicate files and created revisions to calculate the storage that can be cleaned up. Bandwidth utilization information for transfers enabled by example embodiments can be tracked and determine transfer performance. Customers can obtain peaks and lulls in bandwidth utilization based on the calculations.

Example embodiments may include integration at the API level to obtain all the data from customer subscriptions. The functionality for the dashboard and API may include the ability to monitor, store or access a created date, encrypted date, or uploaded date. The functionality may also include search by checksum, search by Cloud ID, make a new revision, identify a created revision, get a secret, duplicate, open, close, write, delete copy, or rename.

The following terms are used throughout the present disclosure:

An “organization” is a company or legal entity that is an overall subscriber to the service. An organization is composed of individual users. An organization can also have a group of devices, a set of IP addresses, etc.

A “Subscription” is a license to a single device that is registered as a client. These may include integration with a transfer mechanism that may include a set of users, such as a Faspex Server, a Box Subscription, or an Aspera in Cloud Subscription.

“Permission management” is performed by the application to control access to a file with a given set of constraints. This may be based on the sharing model that exists in these apps.

A “Device” may be a server or computer that has a processor for running the client application that includes a file system and a network or is a connected device to access the key management system.

A “File” is a single data entity which is a sequence of bytes that can be a video, image, audio, text, document, etc.

An “Encrypted File” is a single data entity that has had encryption applied to the file.

A “Decrypted File” is a single data entity that was encrypted and has not been decrypted. It should be the same reproduced file as before the encryption was applied.

A “Package” is a group of files.

“Users” are people or system accounts that may have associated emails that are registered and tracked with an application or have access rights associated with them.

“Computer IDs” are unique IDs in computers such as a MAC address associated with a network card to a Machine ID or is a Universal Unique Identifier (UUID) or Globally Unique Identifier (GUID), used to reference a device. These can also be used as device IDs to uniquely identify a device.

“Applications” or “Processes” are the application running on a device that is used to access the protected file. This could be a commercial application such as Microsoft Office Products like Word, Excel or PowerPoint to Adobe Photoshop or proprietary applications used to process or access the file. The applications may be used by a user or a process running on the device.

An “Administration portal” is an application accessed over the web for setting policies, review auditing of data and other functions related to the end to end transfer of files. The administration portal interfaces with the backend application.

A “Backend server/application” also known as the “Server,” is the underlying hosted backend application that consists of the underlying Key Management System, distribution tracking, user tracking, organization, subscription and device tracking that includes a user portal or dashboard. An application programming interface (APIs) may exist to perform functions and access from the clients as well.

A “Key Management System (KMS)” is part of the backend system used to create and store the keys used to encrypt the content. It can be hosted as part of the cloud platform utilizing the native key management system like the AWS, KMS or Azure. In one embodiment the keys in the key management system are encrypted before stored. A key can be created per customer subscription for use to encrypt all keys associated with the files for that customer. This can be implemented for example using the Azure Vault service and creating a key per subscription. This key is used to encrypt all keys in the database associated with that customer. That key can also be used to encrypt any additional user or usage data as well. Further, the customer keys can be stored using a master key as well so that keys for subscriptions are never stored in the clear.

A “Proxy Server” is a server application that is used to proxy connections from two different network environments such as a closed network environment to a public network environment or the Internet for a connection to the Backend Server and Key Management Systems. It may pass the API calls directly or it may store and forward the calls. Examples of proxy servers are Squid proxy, Microsoft Proxy, etc.

A “Subscription admin” or “Admin” is a customer employee or agent whose job is to create and support the customer's subscription.

An “Account” is composed of an email and password which a customer uses to login in portal or dashboard as part of the backend services.

A “Client” is an application that is used to access the backend services on a client's device or server.

A “Client email” is an email address that is used to access Faspex or another user email to identify the user and can be associated with an account or end-user.

A “file descriptor” is a set of data that can be added to a file that may include one or more of the following of a unique file identifier, which may be a GUID or some other unique number associated with the file, an associated organization or subscriber identifier the file is associated with, a user or device identifier the file is intended for. The file descriptor may also include a hash of the original file before it was encrypted. The file identifiers may be stored in a local data at the root of the storage file system, at a server or as an index to the key management system to retrieve keys or other associated information to the file.

A “file identifier” is a unique number used to represent an identifier for a file. This could be an embedded file ID such as a GUID or it can be a hash of the value such as a SHA1, MD5, etc. This hash could be of the current output file, excluding the header with the stored file identifier. In another embodiment the file identifier could be stored in the tail of the file or some other location in the file. A receiver will use a file identifier extractor to read or remove the file identifier from the file. A file identifier or file descriptor can be associated with an organization or subscription.

A “Virtual Directory” can be a virtual mount, a virtual mount point, a symbolically linked directory, or a file system overlay. It could point to a directory to a local storage, network storage, shared storage, or to cloud or remote storage. A virtual directory could also be a directory name that can map to a physical directory on a local server's hard drive or a directory on another server (remote server) or storage device. The virtual directory may have an active process or software application that occurs or processes the data when it is accessed, such as by a read or a write operation by the file system and requesting application.

A “Network Address” is an identifier for a node or host or system on a telecommunications network. Network addresses are designed to be unique identifiers across the network, although some networks allow for local, private addresses or locally administered addresses that may not be unique. A network address may consist of an IP Address, MAC Address or address identifier.

A “Network Address Verifier” compares a network address against a predefined network address or set of addresses or portions of an address to determine if it is a match. The list of addresses could be used such as an allowed list of addresses or a whitelist or a list of disallowed set of addresses or a blacklist that is not allowed to access a file.

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

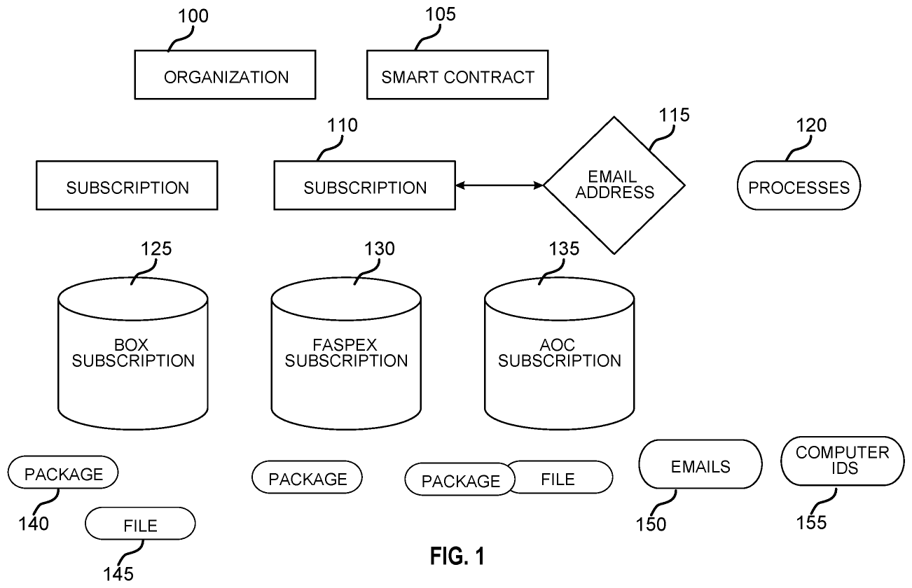

FIG. 1 shows an example of information relevant to a system for data distribution according to aspects of the present disclosure. The example shown represents an example of the relationships between an organization 100, smart contract 105, subscription 110, email address 115, processes 120, box subscription 125, first subscription 130, second subscription 135, packages 140, files 145, emails 150, and computer IDs 155. These elements may be displayed and manipulated in a user interface as described below.

Data distribution may include any means to move a file or other data from one device to another device. This can take place over various means of file transfer. Example file transfer methods may include an operating system file system (e.g. Samba, CIFS, NFS, Posix), Email, Cloud-based file and storage sharing, Google Docs, Dropbox, Box.com, the Internet or LAN or WAN, a local or network storage system, Aspera-UDP based, Faspex, Signiant, FTP (File Transfer Protocol), HTTP (Hypertext Transfer Protocol), FTPS (FTP over SSL), HTTPS (HTTP over SSL), SFTP (SSH File Transfer Protocol), SCP (Secure Copy), WebDAV (Web Distributed Authoring and Versioning), TFTP (Trivial File Transfer Protocol), AS2 (Applicability Statement 2), AFTP (Accelerated File Transfer Protocol), or Peer to Peer (P2P), such as Bit Torrent.

According to an embodiment of the present disclosure, a user may create a subscription 135 to a file distribution service by filling in form fields such as Company name, Admin name, Account email, and a Password for account.

With subscription administration, an admin can have access to multiple subscriptions 135, and switch current open subscription. From the UI, an admin can perform a single operation (single row) or multiple rows of operations (i.e., bulk operations). This may include giving rights to a user or organization in an account to set access rights or respective permissions for a given file.

An admin can see dashboard created on subscription's data. The dashboard may include clients active in time period (i.e., a week), new files rerated during the time period, or other relevant information. In some examples, graphs can be displayed as part of the portal or dashboard as well. These may include actions in time.

Packages 140 and associated files 145 can be displayed in multiple views by the portal and dashboard. For example, a user interface may enable an admin to list all packages sent or received by all clients, display graphs to display when packages have been received/send over time, traverse each package history—the package was sent and reverse by which client/email address (link to actions with filter), revoke rights to package/packages, or grant access to packages.

In a client view, an admin can see all the clients that tried to access a subscription 110. A list of clients may contain an ID (with the ability to go to Actions with filter by the client), a client version, a description, a first access date, a last access date, and a MAC address and/or IP address of client.

For every client, an admin can block access to the subscription, revoke authorization (client should resend activation code), list all packages received by the client and client email address, and revoke access to the package 140 by the client or associated email 150. An admin may be allowed to perform a bulk operation across multiple clients. Bulk operations may include all the above activities.

In an actions interface, a user can access client actions (e.g., open, create and etc.) made within the subscription. A list of actions may contain a client email, a client ID, a device ID, a package 140, an action, and a date.

In an Accounts view, a user can create/modify/delete additional accounts for the subscription. A list of accounts in this view may contain a unique ID, i.e. a GUID used to map users into group, orgs etc., a name, an email, a description, a role, a last access date, and a number of files accessed (filterable for a date range).

An identity management system can further provide relationships of one to many or to other identity management systems such as those that provide single sign-on (SSO). This provides for seamless integration with multiple providers for sending and receiving content. These may include Signiant, Aspera, Faspex, Box.com or Google Drive as examples. Other providers may also include the customers or company's own user management system whether Microsoft Identity Management, Active Directory, Google Authentication, or other systems.

The identity management system creates a single sign-on system in itself for others to link with as well. This simplifies the management of multiple accounts on user systems. Therefore, a customer doesn't have to log in to multiple systems and can have better control over user management. SAML based with OAUTH can be used to collect the initial credentials and allow linking to the account and utilize JSON Web Tokens (JWTs) for subsequent access requests. This allows the collection of tokens and maintains the connectivity to the servers and validates where appropriate. Subsequently, it provides a valid token when user logs into the client.

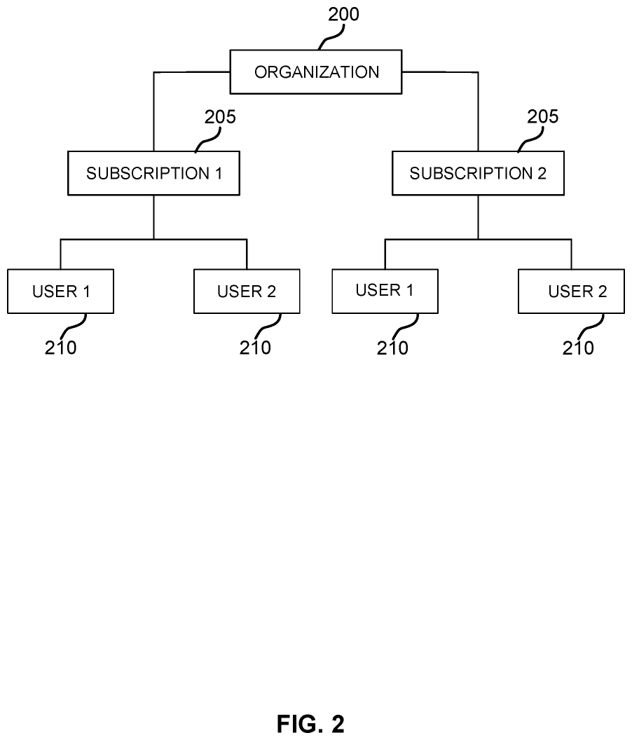

FIG. 2 shows an example of a subscription model according to aspects of the present disclosure. Organization 200 may include subscriptions 205, which may include users 210. Organization 200 and subscriptions 205 may be an example of, or include aspects of, the corresponding element or elements described with reference to FIG. 1.

An organization 200 may represent a superior entity to a subscription 205 and contains multiple subscriptions 205. Billing may be available at organization level, but may have reporting at each subscription level. Each subscription 205 may be classified according to a transfer mechanism or technology. Each subscription 205 can have a distinct set of users or share the users with other subscriptions within the organization.

An organization 200 may also include one or more specialized roles. For example, the organization 200 may have an admin—i.e., a user 210 which was created on org creation. The admin can create new users 210 and delegate them access to one or more subscriptions in the organization. Thus, each subscription can have its own admin(s).

In some cases, there can be multiple types of admins. For example, an organization admin can administer all of the users and associated settings and configurations for the organization. There can also be an administrator for a subscription 205 that administer a subscription 205, which may include multiple organizations 200. Admins for particular roles can preregister users 210, preregister a client or respective client devices for a given organization 200 or subscription 205 for their respective rights.

In some cases, an admin may have an ability to filter actions/users/files with regards to his or her access level. The organization admin can filter by any subscription 205, and org. A sub-admin can filter only by her subscriptions in the organization 200, by one or all together. In some cases, org admin may have an ability to filter all actions by user's email.

According to various embodiments, a user interface may be provided which displays a new organization page, or a new subscription selection control in other pages. In some examples, customers may procure the service and access to the software. For example, a provisioning flow may take customer information, register their organization in the database, create the user's account as an administrator to that organization, use customer's information to set up billing, send an email out to the customer with access to the Admin portal, and preregister any client or client devices.

In some cases, a customer may utilize templates or pre-created profiles that may include whitelisting and blacklisting of process names for application filtering. For example, a Visual Effects Artist (Vfx) may utilize particular set of tools such as Autodesk tools, i.e. Maya, Houdini, SideFx Tools, 3Ds max, Adobe tools include Adobe Photoshop, Premiere, or other tools. In some cases, a customer may utilize templates or pre-created profiles that include particular regions i.e. North America, or blacklist particular countries. In some cases, a customer may utilize templates or pre-created profiles that include working hours for a given location.

As an example of an onboarding system, a provisioning API may be used. A provisioning system may make an API call with the below information when the customer account is created:

```
{
  ″SFDC_CustID″: a,
  ″Organization Name″: b,
  ″Email″: e,
  ″First Name″: f,
  ″Last Name: 1
}
```

A backend API may accept the registration/provisioning request and do the necessary things (as mentioned above in the bullet points). Users who visit a web site can also fill out a form and the information is stored with the customer status as “exploratory”. When a sales team has enough to mark them for evaluation/permanent account, they may switch the status accordingly.

In some cases, the workflow may include a user landing on a public page with some marketing information about the product. The transaction may be in a state that rolls back when something goes wrong—i.e. to prevent partial registrations. A registration form may be hosted on a secure web server that links to the main website.

The form may provide status information for the customer and may end with a message that conveys either a successful registration or something went wrong (already registered, etc.) In some cases, developer credentials may be procured.

At the level of an Organization 200 or Subscription 205, a backend may store which applications/processes can open the files. Only to these applications will the files be served decrypted. The whitelist may be altered only by org/sub-admin on org/sub-level.

In some examples, an API endpoint may return true or false regarding the application's eligibility to receive decrypted content. In other embodiments, the application will get content decrypted, the application will get the content encrypted (for example in the case of an application trying to copy the file) or the application will not get content at all. An example of the application that will get content decrypted would be a copy or move action. An example of an application that will not get access to the content at all is windows explorer and finder. The latter may be used for processes that combine multiple operations in a single package.

Allowing whitelisting may give an admin a choice—to allow permanently or for a time window. A WebSocket API, for example, is needed as the client that sends the file or package may be able to set this as well.

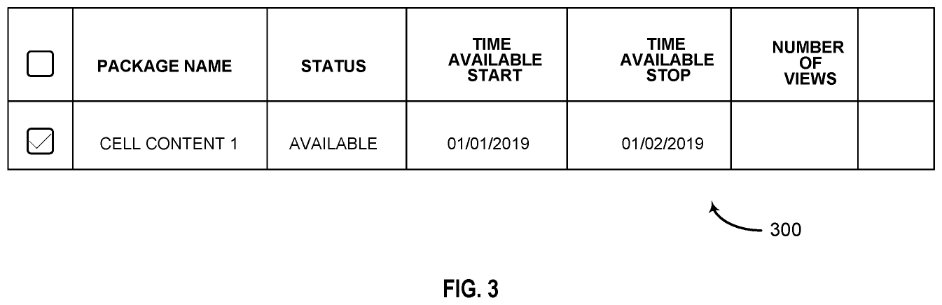

FIG. 3 shows an example of an administrative user interface (UI) 300 according to aspects of the present disclosure. For example, the administrative user interface 300 may be a portion of an application that enables viewing a package name, a status, a time available to start, a time available to stop, and a number of views.

In some cases, a file distribution system may include a UI for creating whitelists and changing them based on a time window or access forever. In some cases, an admin UI may support SSO login. An organization may also support configuration of a SAML setup.

The UI may include the ability to define a start and end time window for a package/file. Outside of this time window, an API may not give the key to decrypt the file. The admin and the client that initiated the package may have access to control when the package is going to be available. Thus, an admin may be able to determine that the package is available for a period of time. The client may be able to have a WebSocket API to control the time window. A client API may be used to retrieve a history of packages that have been initiated by the client. The UI that the client renders may come from the server.

In some cases, a file distribution system may include an option to control how many times the file can be opened. The option may be controlled by the client and can be changed on the server. The admin UI may display how many times the file has been opened. The server admin may be able to adjust the number on the fly (such as to add a rolling time, for example, 7 days from the time the file was opened). Thus, the system may enable changing time windows from a web user interface.

According to embodiments of the present disclosure, a backend table may have fields of client id or device ID and secret along with subscription URL. A backend may accept URLs for file service and then verify. The backend may authenticate using the client id or device ID and secret. In some cases, the backend checks permissions on files for the current user before sending the key.

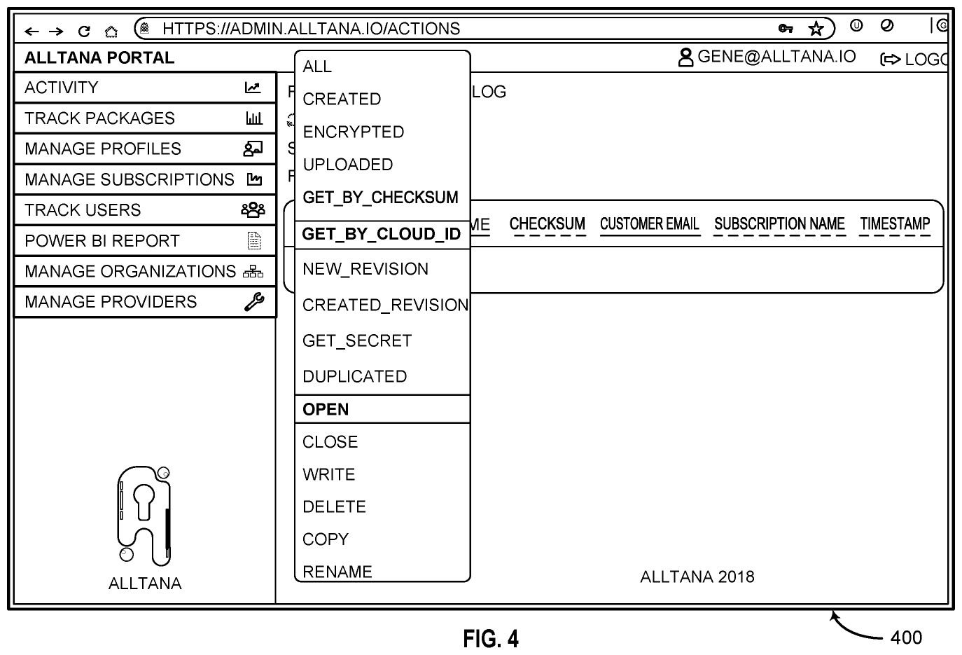

FIG. 4 shows an example of a user interface 400 according to aspects of the present disclosure. Menu functionality of the user interface 400 includes Activity, Track Files/Packages, Manage Profiles, Manage Subscription, Track Users, Business Intelligence Report, Manage Organizations, Manage Providers.

In some cases, integration areas with customers may include Content Management Systems (CMS) or Media Asset Management (MAM) systems or similar types of environments. In one embodiment they may decrypt the file and upload to the MAM and not be part of the workflow. In another embodiment, the files are encrypted and use an Exchange server to allow for decrypted access when needed from the storage device or the MAM itself.

In one embodiment the key server identity systems or the Key Management Systems (KMS) can be integrated into a customer's or 3rd parties KMS system which could include AWS, KMS, etc.

In one embodiment the network/security systems may be on a completely separate network that is isolated or private. In this case a store and forward server acting as a proxy to the outside world to proxy all connections and not expose the rest of the network and associated devices to the outside world. In this case, centralized transmission teams and servers could be used for transferring content between the networks as well.

In one embodiment, the recipient of a secure asset which could be part of an internal group or organization that has rights to the file can be designated as the authorized receiver. This could include for example the recipient of a secure asset (licensee of the content provider who receives a mezzanine file) or a recipient of the secure asset (licensee of the content provider who receives encoded files such as adaptable bitrate files (ABRs)

In an example embodiment, the user interface 400 may be applied to a file distribution system in the financial industry. Such a system may enable collaboration between different business centers, or between offices in different geographic regions. A file distribution system may replace email-based workflow with secure file exchanges. In some embodiments, an audit trail may be kept. Furthermore, a system may not have any file size limitations (like email often has).

Embodiments of the present disclosure may also be used for other potential markets including Biotech which includes Personally Identifiable Information (PII) health data including labs, x-rays, scans and imaging along with genomic data—moving around genomic data and who has access to it, it is important and given the large size of the files. The physical documentation that is around it that can only be seen by certain people. Further, an audit record exists to ensure the permissions and authorizations have been followed.

Embodiments of the present disclosure may also provide other potential works or content availability windows in the media industry, including for pre/theatrical content, dailies, short segments to VFX providers, theatrical assets for localization/review, all home entertainment, PR/promotional content (TV or film), screeners, or for actor guilds.

Embodiments of the present disclosure may also provide for a software distribution application. In the software distribution scenario, a user could be added to a whitelist of users that are allowed to access the encrypted file for installation as an additional security measure of the installation process. As part of the installation, the encrypted software would be delivered as part of the installer. The install would create a new location on the drive for the protected files via a FUSE drive and install the client software. The client would communicate back to the backend server for authorization to continue the installation. The installer would access the file on the protected drive and be the only whitelisted and authorized process to add another level of security. After installation, the installer could remove the respective FUSE connector and clean up the encrypted files.

In one embodiment the allowed file read count can be set to one, and after the file is read it is deleted from the drive. In this embodiment, the system may be used for video distribution, music distribution, or meta-distribution system—which may utilize some other provider to verify rights.

Embodiments may further include a file sharing service, and may provide a gatekeeper for access to such a service. For example, a service may include P2P, Torrent, or file distribution.

In another example, embodiments of the present disclosure may be applied to a digital cinema application. In this case, keys may be windowed and keyed to the projector. In some cases, keys are transmitted electronically. A user may login from the device once.

Other applications include financial transactions (e.g., hedge funds or trading desks in multiple locations), database backups and DR scenarios, alternate distribution methods such as P2P, Torrent, etc., localization, download and playback of a file for subtitling or dubbing, as well as theatrical and home entertainment

Other integration options include tying the file distribution system into forensic watermarking solutions (e.g., Civolution, Irdeto, Verimatrix), and blockchain-based (p2p) video solutions where distributed encoding are used. In some blockchain video solutions protection may be applied to each segment of a file (instead of a whole file). Further applications can facilitate working/integrating with automated workflows. In these cases, an automated workflow is going to receive the file (vs a human) and request access to it.

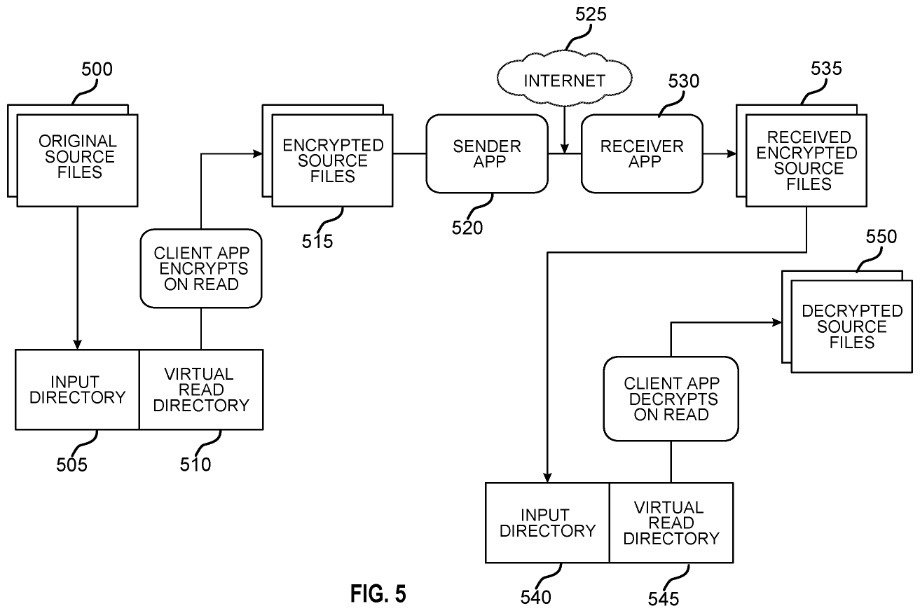

FIG. 5 shows an example of a data flow according to aspects of the present disclosure. The example shown includes original source files 500, first input directory 505, first virtual read directory 510, encrypted source files 515, sender application 520, network 525, receiver application 530, received encrypted source files 535, second input directory 540, second virtual read directory 545, and decrypted source files 550. In some examples, the first input directory 505 and the first virtual read directory 510 are the same directory.

As shown in FIG. 5, a simple data flow includes adding an original file or set of files to an input directory 505. Associated with the input directory is a first virtual read directory 510 (e.g., created by a FUSE mount). When the files are read from the first virtual read directory 510 they are encrypted by the client application as the file is being read off the disk and passed to the reading application.

Encryption may be performed by a separate application or sender application 520. The encrypted source files 515 are then sent to a receiver application 530 and stored in an input directory in the receiving device. Later when an application reads the files back it is from a second virtual read directory 545 and the client application decrypts the files as they are read from the calling application or process.

As a result, the decrypted source files 550 are passed to the calling application for use. In one embodiment the file does not need to be read completely to be decrypted. It can be read in segments or at particular byte offset requests in the file for only using part of the file.

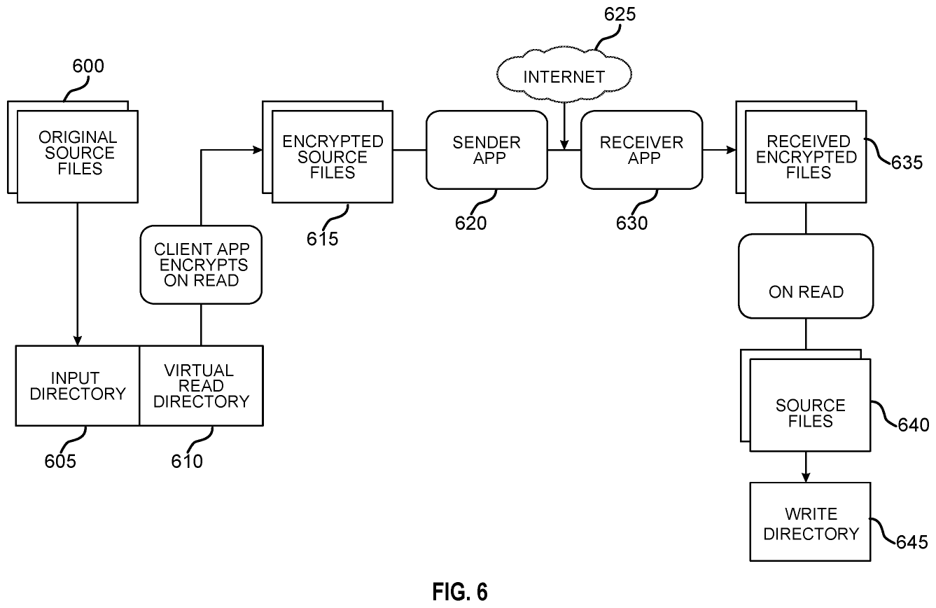

FIG. 6 shows an example of a secondary data flow according to aspects of the present disclosure. The example shown includes original source files 600, first input directory 605, first virtual read directory 610, encrypted source files 615, sender application 620, network 625, receiver application 630, received encrypted source files 635, decrypted source files 640, and write directory 645.

As shown, FIG. 6 shows a secondary data flow that includes adding original source files 600 or set of files to first input directory 605. Associated with the first input directory 605 is a first virtual read directory 610 (e.g., created by a FUSE mount). When the files are read from the first virtual read directory 610 they are encrypted by the client application as the file is being read off the disk and passed to the reading application. This could be a separate application or sender application 620.

The encrypted source files 615 are then sent to a receiver application 630. For this use case, the files are written to a virtual directory. As the files are written the client application receives the file segments and decrypts the files and writes them to the target storage device (e.g., write directory 645). The end result is the decrypted source files 640 are stored on the storage device.

According to an embodiment of the present disclosure, a hash is computed on the unencrypted source file for verification. If the hash that is computed on the source is detected as being previously encrypted the same encryption key is used for the subsequent encryption to achieve the same encrypted file again. If the file has been revoked or expired, a new key is generated for the encryption to create a new distinct output file.

As the content is encrypted a hash is computed to track the encrypted content. This hash is later used to lookup the content and determine access rights, and the associated decryption key to be used with the content. The content can be sent over any method to another receiving client. The receiving client application computes the file hash and stores it locally.

Upon request to access the file, the file hash or the file identifier is sent to the backend server to request an associated decryption key. As part of the process, a device ID is also sent. If it is received via Aspera or Faspex the user ID of the receiving user is also sent back to the server. In another embodiment, the user ID may be requested or previously associated with the device ID.

If a file is received at the client to be decrypted and the backend server does not have a matching hash then the file cannot be decrypted. After the content decryption key is received, along with the hash of the expected decrypted file for verification it can be decrypted. The resulting decrypted file can then be verified against the original source file's computed hash to verify the file was decrypted properly. A hash that does not match indicates a corrupted file in the decryption process.

The client application can further compute both encrypted and decrypted file hashes during the file read and write processes and while streaming the file over Aspera or reading application sending the data as is to ensure the integrity of the file at all times.

Additional scenarios include computation of the hash when downloading a brand-new file, never encrypted or when sending it to someone else. or decide to open the file in another application can compute the unencrypted checksum for verification.

In another embodiment the encrypted file can include a file identifier in the header of the file. This could be a BIG INT data type that can be uniquely generated just like a GUID and stored in the header. This encrypted file identifier would be sent to the server along with the hash of the encrypted file. Either of these file identifiers could be used to determine the file and retrieve the associated rights and decryption key for the file. The advantage of the embedded file identifier is in streaming situations the file identifier can be received at the start and be used to retrieve the key to decrypt the rest of the file while it is downloaded or streamed.

In another embodiment the file identifier could be returned by the server instead of generated by the client when an initial encryption key is returned. After the file is encrypted with this embedded file identifier, the final file hash of the encrypted file is returned back to the server. This method may also mitigate concern for having to decode two files that may coincidentally have the same encrypted file hash.

In some cases, the checksums are stored in a local database at the root of the storage file system (using the filename, file size along with the hash of the file) and back at the main backend server. It gets sent back to the server for validation. The hash is sent back client to server, and the client won't be able to get a set of keys without a valid match of the encrypted hash.

In another embodiment, a file descriptor is added to the file that may include one or many of the following of a unique file identifier, an associated organization or subscriber identifier the file is associated with, a user or device identifier the file is intended for. The file identifiers may be stored in a local data at the root of the storage file system. This may include the filename, file size and file identifier or associated organization or subscriber identifier. These values may further be stored in the online database. Further part or all of the file descriptor gets sent back to the server for validation. The file descriptor information is sent back client to server, and the client won't be able to get a set of keys without a valid match of the file descriptor information including the file identifier.

The client application can run on the host computer of the application or user that is trying to access the file or it can run on a separate device that exposes mounted directories to another computer or accessed over a stream. Further, the client application can access storage that is a separate appliance such as network-attached storage (NAS) or storage area network (SAN) or another device. The files are encrypted on the device and it is the client application that reads the content from the networked storage device and in real-time decrypts the file as it is passed to the calling application or file reading the application.

In the encryption process, the Key Management Server generates the keys to be used for encryption. A query is made into the database if it has a match to the size and hash of the file. If it is a match, then the keys are retrieved. Sending the same source file again will get the same set of keys. In other use cases, a locally generated file identifier may be used instead of the hash of the file. This file identifier may be the same for the file over time or it may be generated uniquely every time the file needs to be encrypted. There is a relationship between the recipient and the keys. The recipient, also known as a target, user may have an associated Client ID, email, be part of an organization or be part of a subscription. The subscription may include a license to the product. The recipient may also be associated with a device. The recipient may also be associated with a geolocation, a radius of a geolocation, or a set of allowed network addresses. Over time the locations of the recipient may be tracked for locations, including network locations, that a recipient normally accesses files. This can be used to determine locations that are abnormal and disallowing access from these abnormal locations. The recipient or the file may further be restricted to access the file with only a set of allowed applications, processes, or application signatures.

In one embodiment encryption is with AES-GCM (AES with Galois Counter Mode) with a key size of 128 or 256 symmetric encryption is applied to the file. In another embodiment different encryption algorithms or methods can be used depending on the file type, file size, etc., and the key management system also stores the encryption algorithm or method used to encrypt the file. This may also include varying key lengths.

AES-GCM is a more secure cipher than AES-CBC, because AES-CBC, operates by XOR'ing (eXclusive OR) each block with the previous block and cannot be written in parallel. This affects performance due to the complex mathematics involved requiring serial encryption. AES-CBC also is vulnerable to padding oracle attacks, which exploit the tendency of block ciphers to add arbitrary values onto the end of the last block in a sequence in order to meet the specified block size.

The Galois/Counter Mode (GCM) of operation (i.e. AES-128-GCM), however, operates quite differently than CBC. As the name suggests, GCM combines Galois field multiplication with the counter mode of operation for block ciphers. The counter mode of operation is designed to turn block ciphers into stream ciphers, where each block is encrypted with a pseudorandom value from a “keystream”. This concept achieves this by using successive values of an incrementing “counter” such that every block is encrypted with a unique value that is unlikely to reoccur. The Galois field multiplication component takes this to the next level by conceptualizing each block as its own finite field for the use of encryption on the basis of the AES standard. Additionally, AES-GCM incorporates the handshake authentication into the cipher natively and, as such, it does not require to handshake.

AES-GCM is written in parallel which means throughput is significantly higher than AES-CBC by lowering encryption overheads. Each block with AES-GCM can be encrypted independently. The AES-GCM mode of operation can actually be carried out in parallel both for encryption and decryption. The additional security that this method provides also allows the VPN to use only a 128-bit key, whereas AES-CBC typically requires a 256-bit key to be considered secure.

One result of an implementation with AES-GCM is when sending or downloading the data, it can create multiple sessions and alternate the sessions from the servers that the file will be downloaded. This allows for load balancing and parallel content delivery from the same encrypted source file for the decryption and delivery process.

In another embodiment the keys are generated locally and are sent to the Key Management Server for storage and association with the file and the associated file descriptor, file identifier or hash. Validation of the file by the client ID and the email address verification is also possible.

Symmetric encryption can be used or in some implementations, asymmetric encryption could be used. In some implementations, it can be one encryption key per file regardless if symmetric and asymmetric encryption is used.

An email may be received and a recipient indicating a file or files are available for accessing. This email may be associated with a file or group of files. Each of the files may have the same or individual encryption keys associated with the files.

An email or client ID basis can be used for user verification or authentication. For example, a MAC Serial number can be sent as the client ID or a hardware ID for Microsoft Windows is computed and then sent as a Computer ID or a Device ID,

In one scenario, a user may auto-download files from Faspex into a dropbox. The user can make those files conditionally available based on timeframe (e.g., the expiration of the file). The user can control this as a sender or also as the IT admin. Files can self-destruct using an expiration date. The app allows storing the files on mounted storage. Every file entry may be linked with its client ID and what computer created it. This allows collaborating on the same file server. Even though a user has not sent a file to anyone, they can still revoke. In some cases, a user can revoke locally in the enterprise.

The client application can determine which applications are allowed to access a file. This is performed through the process pipeline as the file is being opened to determine the process that is accessing the file. A list of processes that are allowed or disallowed to access the file is retrieved from the backend server to determine permissions. If the user or process does not have access rights it will just be returned as the encrypted file and the application will give an undetermined format error. Always on bidirectional to the client to tell the client that a key has been revoked. It leaves the connection open and has a heartbeat line. Constant connection open.

In some cases, a system may verify the application or process signature at the beginning of the file access request process. If the signature is approved, and the process is requesting encrypted content only then the files can be allowed to be copied. If the process is requesting decrypted content, then the process is further checked if it is allowed or blacklisted. Tools such as the OSX finder, Windows Explorer and others can be blacklisted to prevent file copying. Note that scripts do not have signatures and therefore are automatically blacklisted from accessing files.

For improved processing, the record of the process should be kept open because often times many processes access for the same file repeatedly and this prevents reverifying the process every single time. This same optimization can be done in caching encrypting keys locally as the same process will make subsequent offsets into a file or request to access the same file multiple times and this reduces traffic back to the server for subsequent requests.

In the event the main backend server is down, files may not be accessed locally. To prevent this case, a local proxy server can be used to prevent this and cache relevant information about the files accessible by a given organization and the specific access rights. This would also allow for local key storage to occur in a cached key management system or key store.

Keys in the local key store are encrypted with the key generated by the key vault system. The key is used to encrypt all of the keys in the subscription or device. The client would need to talk to a different endpoint.

Multifactor authentication of the user may be done to improve the security of the application and file access process. The client is registered for the first time. The code is sent to the email for verification of the organization. Further could allow an admin to be authenticated using text messaging, RSA keys, or a QR code/URL based authenticator application such as Google Authenticator, Microsoft Authenticator, etc.

One feature of certain embodiments is to allow more than one email associated with a client device. They will be tracked differently and whitelisted. Users, groups, and organizations may to be added to the system—they can be used for single-user delivery or multiple user blacklisting or whitelisting within an organization. Further, the files can be set up account-based. Thus, can have individual FUSE mounts per user so that only an approved user in that storage system mount can access the file.

A Filesystem in Userspace (FUSE) is a software interface for Unix-like computer operating systems that lets non-privileged users create their own file systems without editing kernel code. This is achieved by running the file system code in user space while the FUSE module provides only a “bridge” to the actual kernel interfaces. FUSE is available for Linux, FreeBSD, OpenBSD, NetBSD (as puffs), OpenSolaris, Minix 3, Android and macOS.

In one embodiment, the files that are protected and stored at rest the filenames are also encrypted. The directory names are encrypted too. Directory rights are based on having a file access key. Key for encryption of directories is with the key of the given subscription. This allows for a shared drive and directory access as long as a user has one file in the directory they have rights to. Encrypted files and directories can be shown as a bunch of numbers on the file system. A user can only see files they are allowed to see with the proper permissions. A key may be received for the directory iterator. With that key can only see those files. There is a local database of the files and directories. The database associates the remote Id of the files to the files on the filesystem.

In another embodiment the original source files written into a first directory are encrypted as they are written into the directory. Subsequent reads from the director can either read the encrypted files for distribution or can be decrypted as they are read. This distinction can be done through the use of two different virtual read directories or be preconfigured for the desired behavior. The system may store the files encrypted ahead of time to allow the files to be protected at the source prior to distribution but still be accessible to processes that have permissions. In another embodiment the process, application or process signature if on a whitelist or blacklist can indicate how the read process is treated if it is sent to the calling application process in encrypted form or decrypted form.

In one embodiment, the space of the output drive for the encrypted files to be read from may be limited. If a transfer application is reading from this output drive the encrypted files for delivery, then the encryption process can be implemented to pace the encryption process with the rate that data is being read to minimize the file space needed. In other implementations, the encryption may be in real-time as the data is read and encrypted on the fly while the data is being read. When simultaneous files are being accessed multiple encryption threads can be used as needed. Performance may be optimized to run the same number of threads as there are CPU cores. In other cases, buffer sizes may affect performance for the reading process.

Some transfer applications utilize a 64K standard read buffer, however, if the files are smaller than 64K this creates a performance problem and may utilize padding. This padding can be done as part of the encryption process or rely on the transfer application to perform the padding. This can be further optimized if reference points are provided to the transfer application instead of having the application query for start and endpoints to determine the read process. File mounts can also have varying chunk sizes and they can be based on the payload size. If the mount point is to a local mount than chunk size could be 1 megabyte (MB). In the case of a UNC path or network path, the chunk size is 4K to allow for system responsiveness over longer network distances and latencies.

In another embodiment the virtual read directory and write directory are the same directory. In one embodiment a file that is written unencrypted to the virtual directory will be read out encrypted the next time the file is accessed. In another embodiment a file that is written and is encrypted to the virtual directory will be read out unencrypted the next time the file is read from the virtual directory. In these implementations the first directory and the second directory can be the same virtual directory.

In another embodiment the databases or servers for the key management process can be separated out either by organization, by subscription, or shared based on keys.

In another embodiment after the file is encrypted and an end user has been identified for the file an email is sent to the intended recipient of the file. The email may contain a security code that is associated with the organization of the user. The security code is associated with an organization or subscription to assist with the authentication of the installation of the client. The security code then allows the user to install the client that can be used to decrypt the received file. The security code has an expiration date. In this implementation the file can be transferred by any method to the user that is separate from the sending of the security code.

In another embodiment the security code may be used only once and may be associated only with the single file that is to be received. Thus, authentication is for limited user authentication for a single file or group of files and not for authentication for that user for future files. In this method a user's email may be used instead of using a unique ID, as in most cases for this implementation that user may not have an associated unique ID and only an email is available for sending the information.

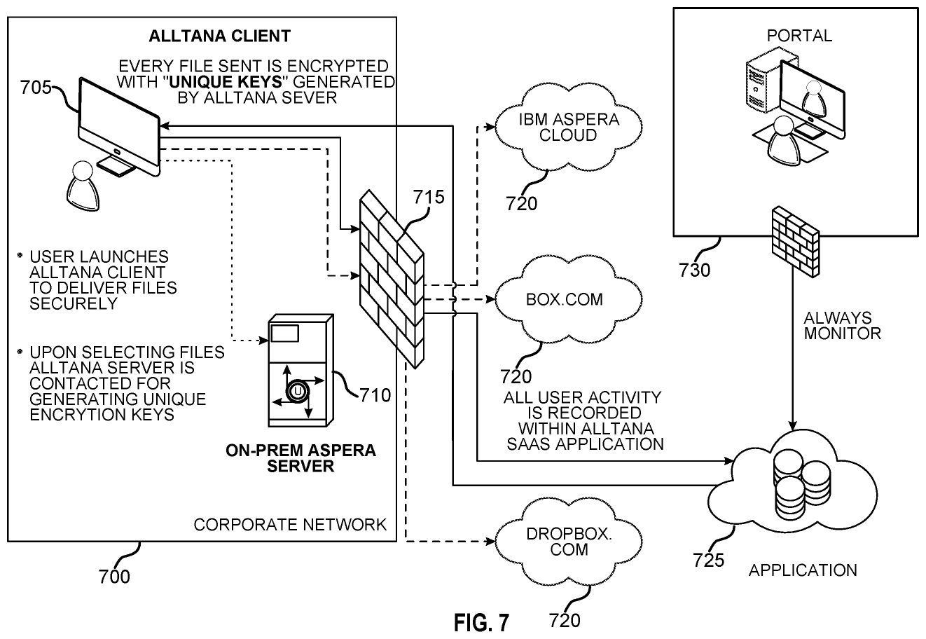

FIG. 7 shows an example of a system for data distribution according to aspects of the present disclosure. The example shown illustrates relationships between corporate network 700, cloud storage 720, SAAS application 725, and administration portal 730. Corporate network 700 may include user terminal 705, server 710, and firewall 715.

As illustrated, cloud storage services may include services such as IBM Aspera cloud, Box.com, or dropbox.com. A user may launch a client to securely deliver files. Upon selecting files, a server 710 is contacted for generating unique keys. All user activity may be recorded within a SAAS application 725.

In one embodiment for integration with the system of the present embodiment, the files are seen as a collection of files in a session. For each to work properly there may be enough file I/O and low latency. Sometimes it goes against a single node on a server, which may not have enough capacity.

In an implementation of the client delivery application, it can measure the rate current files are being uploaded or read from storage and decide on which server endpoint to deliver the next file or segment based on the actual speed or append the session or switch over to read from a different server to pull the rest of the file from. This delivery can be performed in parallel from multiple servers as well. Further, the technology allows for non-continuous reads of the file to be performed as needed.

For example, in playback of a video file and skipping to the middle of the file allows the byte offset read requests to index in the middle of the file and pull the respective encrypted data which is decrypted upon access in the middle of the file and returned to the application in a transparent manner. While a full verification of the hash of the decrypted file cannot be computed in this manner the full encrypted file at rest has already been verified.

For centralized storage, every desktop that will access the files may have a client application to do the decryption. This can be performed through a virtual mount of an external centralized file system where the files are actually located.

In an example application, a true certificate of distribution can be provided with assurance that the file has been received and in its entire encrypted state and can remain encrypted at rest.

In one application a user can track version ups (newer or subsequent versions) on files and disable old version of a file so can't accidentally use. A file versioning hierarchy can be formed and also notifying previous users that have accessed a file that a newer version is available for use and the previous version has been disabled. Select which people in an organization or group can get access to a file.

In one implementation the client application to decode the file could be a plugin within the application. In another implementation working hours can be set when the file can be accessed. This can prevent unlawful after-hours usage of a file by an individual. This can be set for a specific user or for a group or organization. In some cases, a file distribution system may store the filename in the database as well because it can often contain the title name and a number of audio channels, etc.

The device ID can be used as an alternative or in conjunction with a user credentials. Users can be restricted to only access content from a particular set of device IDs. This prevents a user from using his credentials on a file that is on his home computer or a thumb drive that is outside of the production environment.

A particular device ID(s) can be automatically provisioned to access a particular set of content/files. This is important for automated workflows where the device ID is part of the automated ingest process.

A new device ID may be obtained and registered with the system including mapping to a company and to a set of users. The device needs to be assigned a friendly name. In the case of automated autoscaling environments, the new devices need to register with the system when they come up and either use an API key, set of user credentials or register with a local proxy server that authenticates it is on a particular subnet and then sends it back to the main key server.

In some applications, logging of attempts legitimate or unauthorized should occur and include IP address, location, GeoFencing, from IP addresses that are whitelisted, etc. The history of access attempts for a given user, organization or set of subscribers can be stored and learned over time. Predictive threat detection can be determined based on considering prior IP addresses and/or associated locations and allow IP address blocks or accesses within the same IP address block registered to the same entity. Files that are accessed outside of previous IP addresses, IP address blocks or a given radius of locations can be flagged and notification to the owner of the file can be made of this suspect activity.

In one embodiment, file access rights are managed in a relational database, no-SQL database, or in a blockchain. However, rather than utilizing centralized organizations or records for this, the blockchain (or distributed ledger) will be leveraged to create immutable records for storing and memorializing such data including ownership files, access rights, hash values, smart contracts, and file access logs. Appropriate content owners will have the same control over their assets and the respective usage and be able to generate revenue (as well as track and monitor) from such content including usage and access of their files.

In addition to decentralization, leveraging the distributed ledger nature of blockchain also provides benefits of property ownership including efficient transaction speed, trust/fraud reduction (via the removal of central authority), liquidity via tokenization (i.e., partial property ownership via tokens), and the use of smart contracts. The following information about blockchain is hereby incorporated by reference as if set forth in its entirety: https://en.wikipedia.org/wiki/Blockchain.

In some examples, the file rights registry may interact with a blockchain to manage rights and information in real-time. For example, the blockchain may engage in the functions of recording, authentication, and authorization of file access transactions, or other if a user has appropriate rights. In some cases, the blockchain may be used to store privacy settings or ensure that an appropriate content owner has the ability to manage such rights and preferences. Further, the blockchain may also be used as a smart contract by the content owner to sublicense the file(s).

In some embodiments, the blockchain can also have the storage of content. In other cases, it stores the content encrypted and unencrypted hash. In some embodiments the organization can set up a separate ledger for storage. A ledger URL to the blockchain request, what happens across multiple organizations.

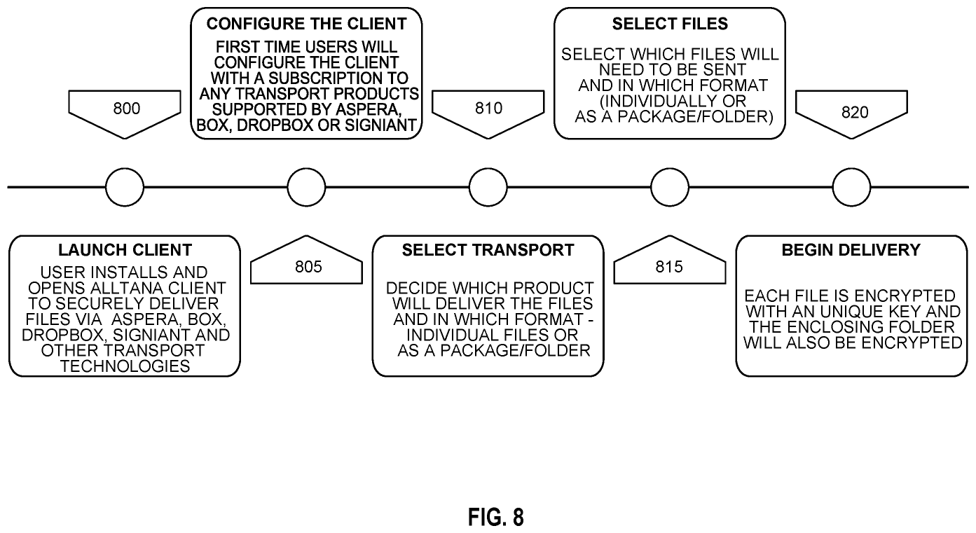

FIG. 8 shows an example of an overview of a data distribution process according to aspects of the present disclosure. In some examples, these operations may be performed by a system including a processor executing a set of codes to control functional elements of an apparatus. Additionally, or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At operation 800, a user launches the client. For example, a user may install and open a client to securely deliver files via Aspera, Box, Dropbox, Signiant, or other transport technologies.

At operation 805, the user configures the client. First time users may configure the client with a subscription to any supported transport products.

At operation 810, the user selects a transport. For example, the user may decide which transport product will deliver the files and in which format, as well as whether they will be delivered in a package.

At operation 815, the user selects files. For example, a user may select which files will be sent and in which format.

At operation 820, the system begins delivery. In some cases, each file is encrypted with a unique key and the enclosing folder may also be encrypted.

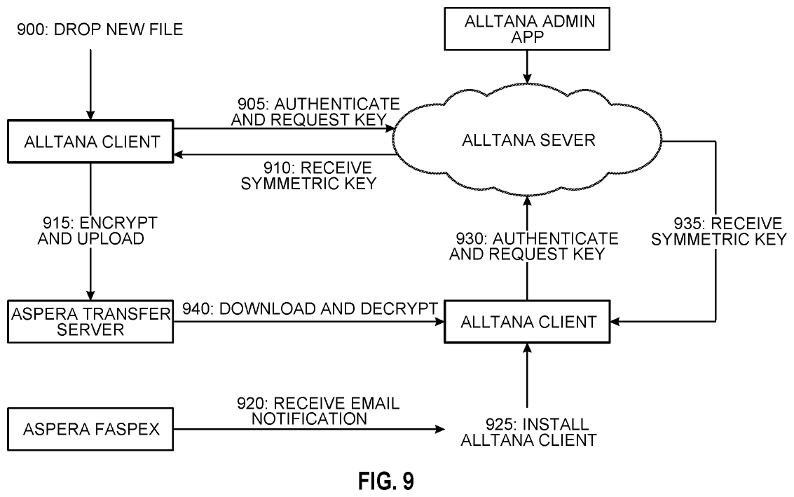

FIG. 9 shows an example of a data distribution process according to aspects of the present disclosure. In some examples, these operations may be performed by a system including a processor executing a set of codes to control functional elements of an apparatus. Additionally, or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At operation 900, a user (the sender) drops a new file. At operation 905, the client authenticates and requests a key. At operation 910, the client receives a symmetric key. At operation 915, the client encrypts and uploads the file.

At operation 920, an additional user (the recipient) receives an email notification from a system server. At operation 925, the additional user installs client.

At operation 930, the client of the additional user authenticates and request a key. At operation 935, the client of the additional user receives a symmetric key. At operation 940, the client of the additional user downloads and decrypt the file.

According to certain embodiments, users may perform an authentication process prior to encrypting or decrypting files. For example, a user may start a client application. The user is then invited to enter the address of the transport server (e.g., the Faspex server), the email address that matches the Faspex account, and the password for the Faspex account.

The client application then attempts to authenticate by transmitting information to the server including a Fapsex server address, a user's mailing address, a SAML Faspex authorization token, a client application ID, etc.

In some cases, the API checks for evidence of ownership for this client application. If the client application is verified, the API authenticates the client application, checks the validity of the SAML token and its ownership to the user with the transferred email. If the client application is not confirmed, the API returns an error with the need to confirm ownership of the client application.

In some cases, the client application shows an additional field for entering the code from the email sent by the server. After entering the code, the client application calls the API method to enter the code.

In a WS authentication example, the following request may be sent to authenticate an existing client:

```
{
  ″command″: ″auth″,
  ″email″: ″test@example.com″,
  ″access_token″: ″pdw3SfwjyguWU″,
  ″alltana_client_id″: ″ideniden″,
  ″provider_url″: ″https://faspex.com″
}
```

The response may include:

```
{
  ″customer_info″: {
      ″last_login″: None,
    ″phone″: None,
    ″email″: ′test@example.com″,
    ″customer_id″: 1
  },
  ′request_id′: ′ws-PqhmB4′
}
```

In another authentication example, a user starts new client, and a wizard prompts for a Faspex server URL, an email address (e.g., for a user account in the Faspex server), and password credentials.

The client attempts to authorize by passing some or all of the following data: a Faspex server URL, a user email address, a SAML token received from Faspex auth, and a client hardware/software unique ID.

The endpoint of this embodiment may perform the following operations. If identity is verified, the API will authenticate, validate the token and token associated with the actual Faspex user. If the client authorization is not authenticated, the API returns an error response and indicates that the client needs to confirm the identity. Client may display a screen indicating that the user needs to enter additional code sent via email by the server. After code submission by the user, the client attempts to verify the code and validates itself and the user.

An example request API for an existing client may include:

```
{
  ″command″: ″auth″,
  ″email″: ″test@example.com″,
  ″access_token″: ″pdw3SfwjyguWU″,
  ″alltana_client_id″: ″ideniden″,
  ″provider_url″: ″https://faspex.com″
}
```

A response may include:

```
{
  ″customer_info″: {
      ″last_login″: None,
    ″phone″: None,
    ″email″: ′test@example.com″,
    ″customer_id″: 1
  },
  ′request_id′: ′ws-PqhmB4′
}
```

For a new client, the API request may include:

```
{
  ″command″: ″auth″,
  ″email″: ″test@example.com″,
  ″access_token″: ″pdw3SfwjyguWU″,
  ″alltana_client_id″: ″ideniden″,
  ″provider_url″: ″https://faspex.com″
}
```

The corresponding response may include:

```
{
  ′message′: ′Need customer confirmation′,
  ′code′: ′CustomerNeedConfirmation′,
  ′request_id′: ′a-WnBpMNx′,
  ′token′: ′4740c99ad04ccb544d3afd5d6b16533a′
}
```

To confirm a token, the API may include:

```
{
  ″confirm_token″: ″pdw3SfwjyguWU″,
  ″code″: ″123456″
}
```

The corresponding response may include:

```
{
  ″customer_ info″: {
    ″last_login″: None,
  ″phone″: None,
  ″email″: ′test@example.com″,
  ″customer_id″: 1
  ),
  ′request_id′: ′ws-PqhmB4′
}
```

In one embodiment, there can be one encryption key per package with which the entire package and all the files within it were encrypted. In another embodiment, each file is encrypted with its own encryption key instead of one key per package. This change increases the question of scalability and raises a lot of concerns. For a large-scale database of keys, a process eventually needs to be created where less used keys or inactive keys are moved to an alternative database to reduce the overall number of keys. Those keys that are expired can be put into an archive database until changed to be active again.

In one embodiment, there is a user-specific key that is being used to encrypt the folder and file names. Further in one embodiment, the key is stored in the client after it is received.

In a first use case, a folder with the file(s) or a file is dragged into the client. There may be an expectation that the client generates an ID that gets replaced at the time of transfer.

In a second use case, a user logs into a file transport service (e.g., Faspex, Aspera on Cloud, Box.com, or Dropbox.com) and transfers a file using one key per file.

Use case 3: A user logs into Faspex/Aspera on Cloud/Box.com/Dropbox.com and transfers a folder; one key per file within the folder.

Use case 4: Existing files/folders are forwarded with additional files.

A further level of security is establishing trust with every client call with Backend servers or system from a sending or receiving device. This can be established when a user enters the subscription details that may include one or more of the following being a user verification URL, an email, a phone number, a device ID, along with an associated organization for the user. Once the user logs into the application they may be sent a confirmation code to the email. When the user confirms the 6 digit code with the application a device can also be authenticated for a user. The authentication code can also include sending text messages. On subsequent sessions for further security a method utilizing passwords, biometrics, two-factor or multi-factor authentication, or touch ID to re-establish identity. A user will have to log in again when the computer shuts down. The system could cache the credentials to prevent a relogin if desired. As another implementation the authentication by the transfer application could further be utilized to authenticate the user. For example, only requiring a user to log into Faspex and can reuse those credentials or the applications authentication of the user. In all of these cases the backend server may reply with an authentication token i.e. a Security Assertions Markup Language (SAML) token or JSON web token (JWT) token, that the client needs to pass in every subsequent call to the server for authentication.

In other embodiments the encryption key may be generated by the encrypting device and the key along with a file identifier such as a hash or GUID, etc., are sent to the server for storage in the key management server. In another embodiment the file identifier and encryption key may be generated by the server and sent to the client when a request is made to encrypt a file. In another embodiment the client device may generate the file identifier and pass it to the server which returns an associate encryption key to use. The server may also include additional file descriptor information to include in the file including an organization identifier or a subscription identifier.

In another embodiment, a simplified version of client application can exist that is not a virtual file system with input and output folders but is a simple application that could either be a command line or graphical user interface (GUI) based application. This application is lighter weight and does not require an installation process.

Using an asymmetric encryption algorithm there is the option for Public/Private key submission to be prompted for in the application and used at the client or in other embodiments the user can allow the client to generate the key pair. In either case the public key is registered on the backend through an API call. After this registration, then the client can communicate with the backend server to authenticate itself. Additional info such as client ID is published to the server along with the key so the client can be later identified and determine the associated public key to use for future communication with it.

In cases where the client is just a daemon integration, no user account is required to be associated with this client. Instead a JSON Web Token (JWT) through linking the account will authenticate the endpoint. This occurs through login into an authorized subscription and paste the public key into the subscription.

All subsequent requests contain the client ID server does the public key lookup to decrypt the message. It becomes a device at that point that is registered. On the server-side platform page it may have a user tab and a device tab, listing each respectively. A list of all devices includes all of these automation client devices not associated with a given user. The devices can also be assigned friendly/description names so that a subsequent user will know how to identify a client device and where it may be located.

In later use cases in sending content to these registered devices, a user can filter on devices or emails when sending a file.

The same devices can also be blacklisted so content cannot be sent from particular devices, users, from particular locations, etc. This can be enforced by either the sending side not sending to these devices if it is blacklisted from it, or the receiving device can also apply blacklist criteria to all receiving files before they are ingested or allowed to be decrypted. The location can be determined through multiple methods including IP address, WiFi triangulation, or requiring location services to be enabled and utilized on the respective computer, server or device.

In some variations there may be only particular authorized users allowed to have access or to be assigned to a registered device. In some cases, if a user is mapped to a device then all content sent or received by that device can be accessed by that particular user or set of users.

In other embodiments it can be specified that only an approved set of devices or servers on the network are allowed to access a file or have a client device and not an individual personal computer.

In another embodiment, devices can be grouped together and can also be assigned to organization. This can also allow for group access to a particular set of users or an organization. In other cases, registered devices can be supported across all platforms.

In one embodiment, as a user experience, after a file is encrypted or before if it will be encrypted before sent, a user may for a particular file or set of files select the file(s) by right-clicking on it, or through a user interface, or on the command line set the permissions which may include the recipients, organizations, or devices to which recipients can access a file. After this the user may transfer the file by whatever means they wish to the destination. At any time, these permissions can be changed, revoked, updated, or added.

Rules can further be configured to utilize client devices allowing users to receive files that are not directly registered users, but anyone that has physical access to that client device may access the file. Even in this case local file, server or storage credentials can be used.

In some implementations a file extension can be used to trigger the respective application to access a file. Further if the associated application is not stored on the local computer or server the user may be prompted to download the associated application either from an applications store related to the operating system such as the MAC or Windows App Store or from another location. If the file was downloaded over a server a MIME type could also be utilized for file association.

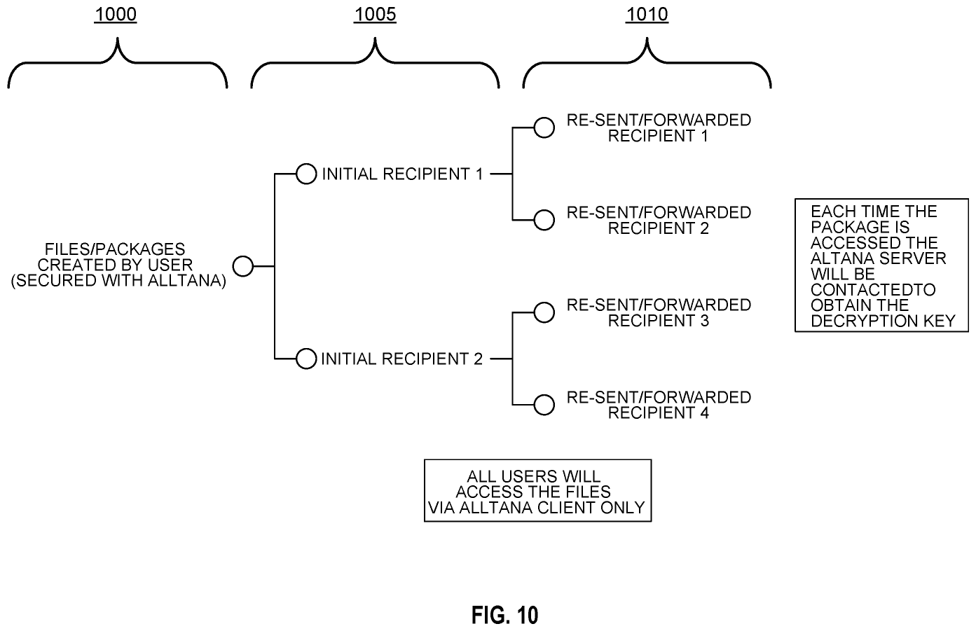

FIG. 10 shows an example of an access tree according to aspects of the present disclosure. The example shown includes files 1000, initial recipient 1005, and subsequent recipient 1010.

In some cases, all users may access files via a system client. Each time a package is accessed, a server may be accessed to obtain a decryption key.

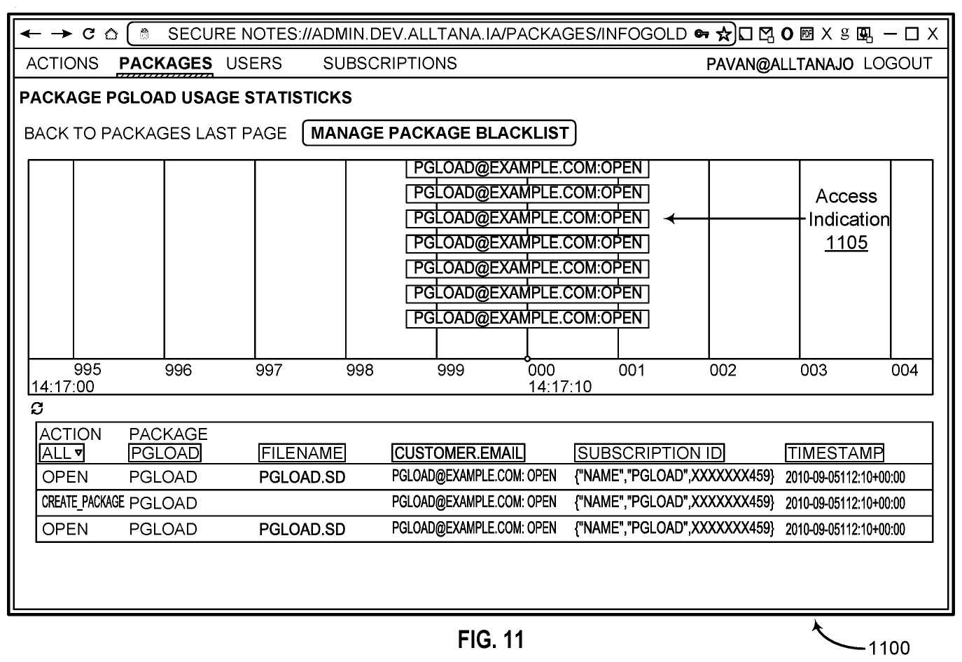

FIG. 11 shows an example of a user interface 1100 with package statistics according to aspects of the present disclosure. Specifically, user interface 1100 illustrates an example where a user may review a package blacklist. User interface 1100 may include access indication 1105. Access indication 1105 may show the status of a package (i.e., a folder of files for transport).

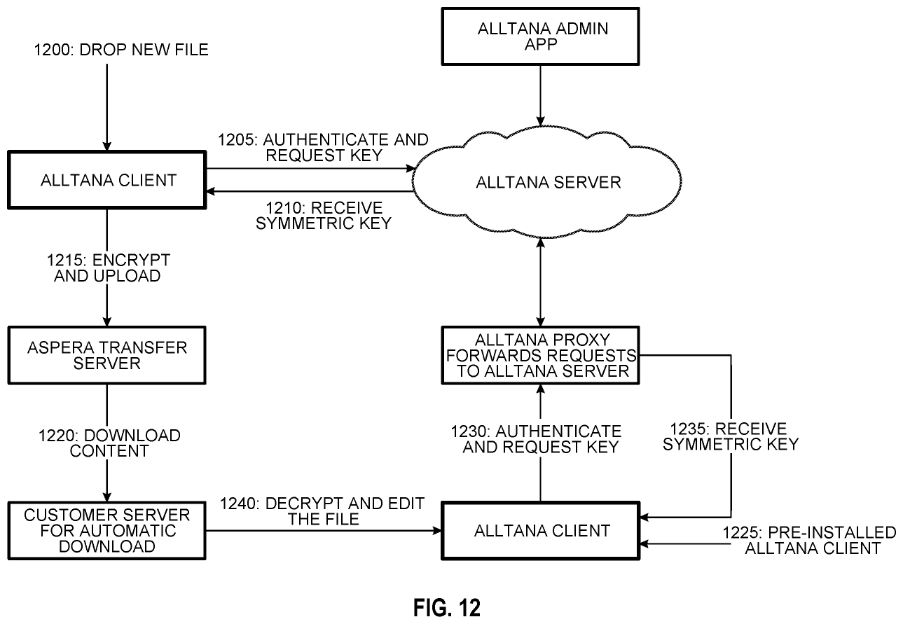

FIG. 12 shows an example of a data distribution process according to aspects of the present disclosure. In some examples, these operations may be performed by a system including a processor executing a set of codes to control functional elements of an apparatus. Additionally, or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At operation 1200, a user drops a new file. At operation 1205, the user authenticates and request a key. At operation 1210, the user receives a symmetric key. At operation 1215, the user encrypts and uploads the file.

At operation 1220, another user downloads content. At operation 1225, the other user accesses a pre-installed client. At operation 1230, the other user authenticates and request a key. At operation 1235, the other user receives a symmetric key. At operation 1240, the other user decrypts and edit the file.

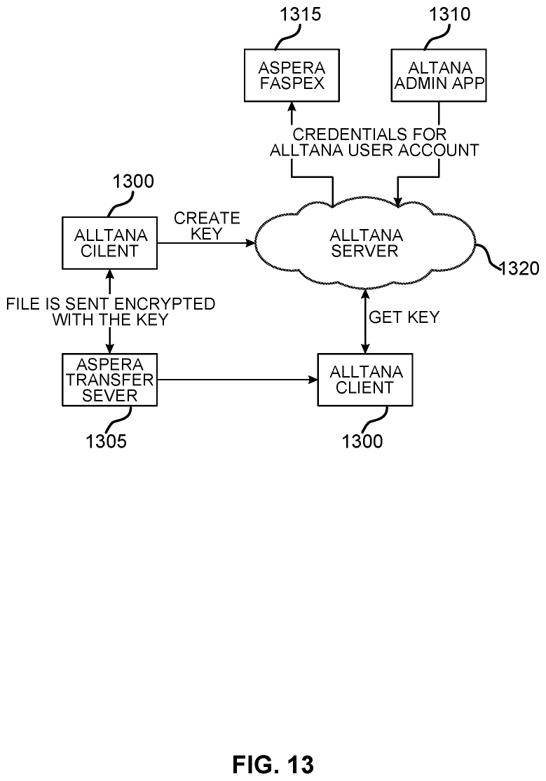

FIG. 13 shows an example of a system for data distribution according to aspects of the present disclosure. The example shown illustrates the relationship between clients 1300, transfer server 1305, admin app 1310, file server 1315, and server 1320. The system shown in FIG. 13 may correspond to the elements performing the operations described with reference to FIGS. 9 and 12.

The client 1300 receives a cropped file, authenticates, requests a key, receives a symmetric key, encrypts and uploads a file. The transfer server 1305 receives encrypted files and transfers them to another client 1300. The admin app 1310 establishes credentials for each user. The file server verifies credentials for each user. The server 1320 generates and provides encryption keys, and authenticates the users of the clients 1300.

Functions of the client 1300 may include: request a key to a file from a backend server, report status to the backend server, stream a file from anywhere on the filesystem and encrypt on the fly, support whitelisting of the processes during open call, support for local storage and mounted storage for effective collaboration scenarios, recompile FUSE ioctrl and bundle it with the client to avoid certification issues, install client and FUSE, and transfer controls.

In some cases, a client 1300 takes advantage of FUSE technology. FUSE provides an alias effectively to a file system folder where the client stores the content. Also, the client may manage a database of accounts and files encrypted with the keys. The database may be located in the root of a secret location and will not be visible to the end-user or terminal user. The name and the content of the database will be encrypted with the subscription level key.

In one example use case, a secret file is located on the local storage. Only one client has access to the file and its managing the relationship between local files and file-ids returned by the server. In a shared use case, a secret file is located on mounted storage. Multiple clients may have access to the database file and track the usage accordingly.

The client maintains the relationship local files to remote file_id in a usage table that may include:
std::string _contentFileHash;
std::string _encryptedFileHash;
std::string _fileName;
std::string _encryptedName;
int32_t _mtime;
int64_t _file_id; //reference to the ref. id.
std::string _account_id;
std::string _computer_id;

Account information may be stored in the following table
std::string _securePath;
std::string _hiddenPath;
std::string _description;
std::string _serverUri;
std::string _computer_id;

Each client has a unique id that identifies it. So, it is possible to track the activity of individual client in the shared use-case, but at the same time allow for group collaboration.

There are several scenarios when group collaboration is important. In some cases, the client relies on the cloud provider web application to be the master record. Essentially if the user has access to the content via the web portal and the user is not blacklisted, it is considered good enough for the client to give away a key.

However, the model may not be suitable when the user simply drags and drops files into the FUSE folder. At that point, the server (i.e., the web portion) has no awareness of the content. The client asks the server based on the inferred parameters, (like filename, email address) whether the file exists in the context of the particular subscription. If the response is negative, the client simply requests a new key and treats it as a new file. Upon closing the file, the client updates the server and local database with the relevant hash information. This works great in the non-shared scenarios.

In the case of mounted storage, the database may be located in the common location, each client will be configured to look at that location first and, if the common location is found, will work with the common database instead. That way all the users of the shared storage will be able to encrypt/decrypt files in a collaborative environment. In another embodiment, the storage paths may be stored in the backend server. When a new client is provisioned it retrieves the information from the backend server which locations are valid.

The client can further be configured for multiple input and output directories. This can allow for locations on different storage devices or different paths on the same storage that may have different content depending on the end user's permissions or other restrictions. In another embodiment at the installation of the client application, it will allow a user to specify input and output locations at that time.

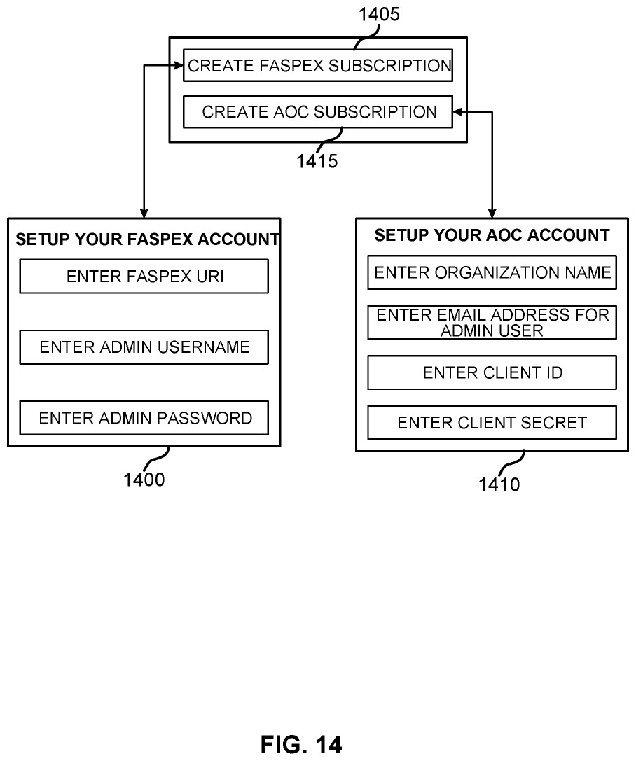

FIG. 14 shows an example of an account creation process for according to aspects of the present disclosure. In some examples, these operations may be performed by a system including a processor executing a set of codes to control functional elements of an apparatus. Additionally, or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At operation 1400, a user sets up a first file transport account (e.g., a Faspex account). The account setup may include entering a URI, admin username, and admin password. At operation 1405, the system creates a first subscription (e.g. a faspex subscription) based on the first file transport account.

At operation 1410, the system creates a second file transport account (e.g. an Aspera on Cloud or AOC account). During the creation of the second file transfer account, the user may enter credentials such as an organization name, an admin email address, a client ID and a client secret. At operation 1415, the system creates a second subscription (e.g., an AOC subscription) based on the second file transfer account.

In some cases, an administrator can invite other users to manage an organization. For example, a user interface may include a page for Admin GUI to add a new user. The fields to create a user may include: First Name, Last Name, Email, Role, and a SAML account (yes/no).

Next, a user receives an email with the contents saying welcome to the Administration Portal. Click here to get access. That link should redirect to a relevant page. Next, if the user has a SAML account, on the login page the user logs in with SAML. If the user does not have SAML account, the link will redirect to the reset password page to set up a password. The link should expire after a time period (e.g., in 24 hours).

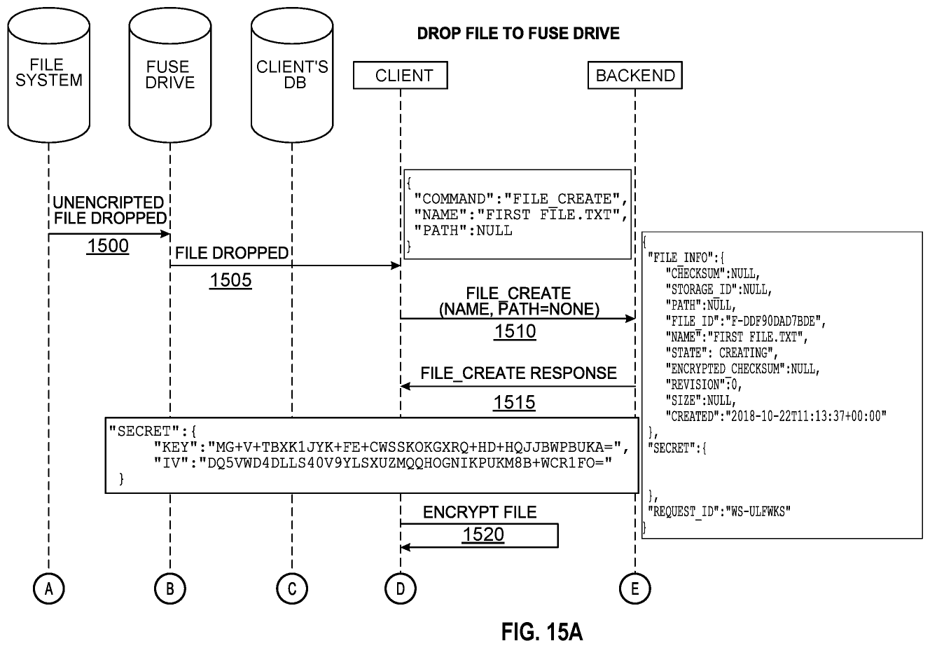

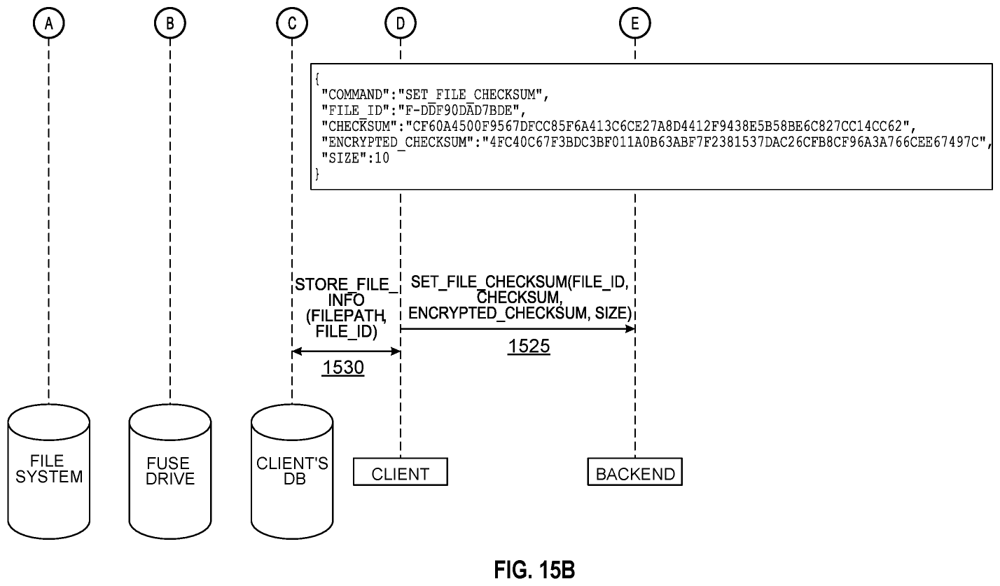

FIGS. 15A and 15B show an example of a process for dropping a file to a FUSE drive according to aspects of the present disclosure. In some examples, these operations may be performed by a system including a processor executing a set of codes to control functional elements of an apparatus. Additionally, or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

According to FIG. 15A, at operation 1500 a file system drops an unencrypted file to a FUSE drive. At operation 1505, the FUSE drops the file to a client.

At operation 1510, the client sends a create file message. At operation 1515, the backend server sends a create file response. At operation 1520, the client encrypts the file.

According to FIG. 15B, at operation 1525, the client sends a checksum message to the backend server. At operation 1530, the client stores file information in a client database.

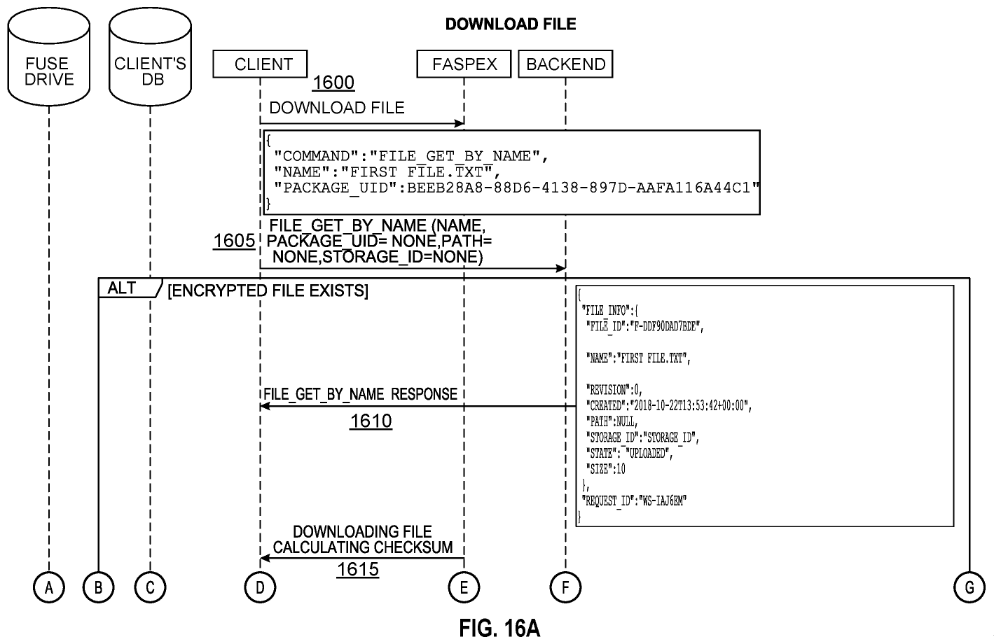

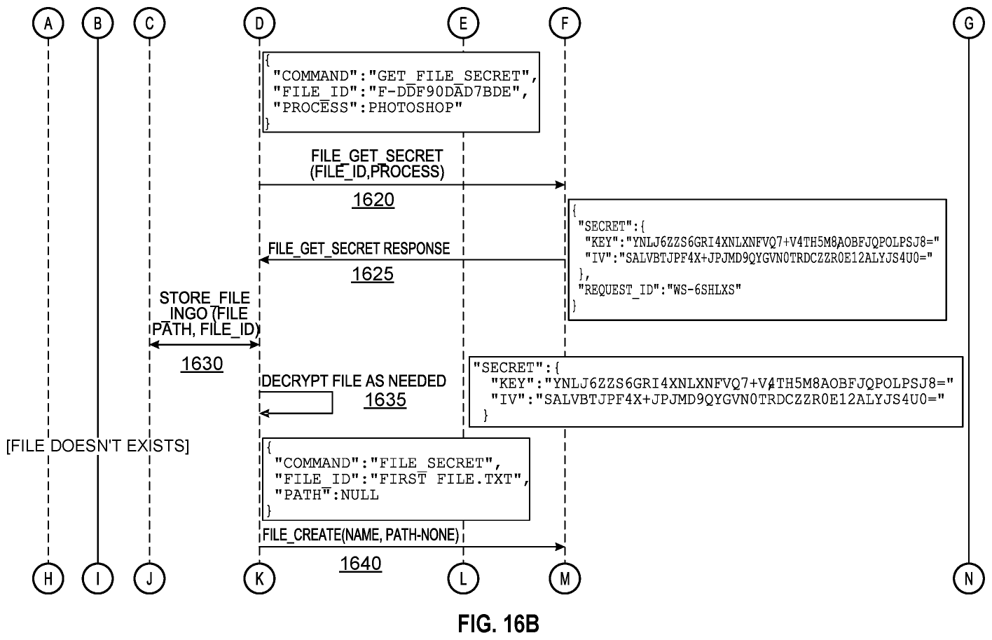

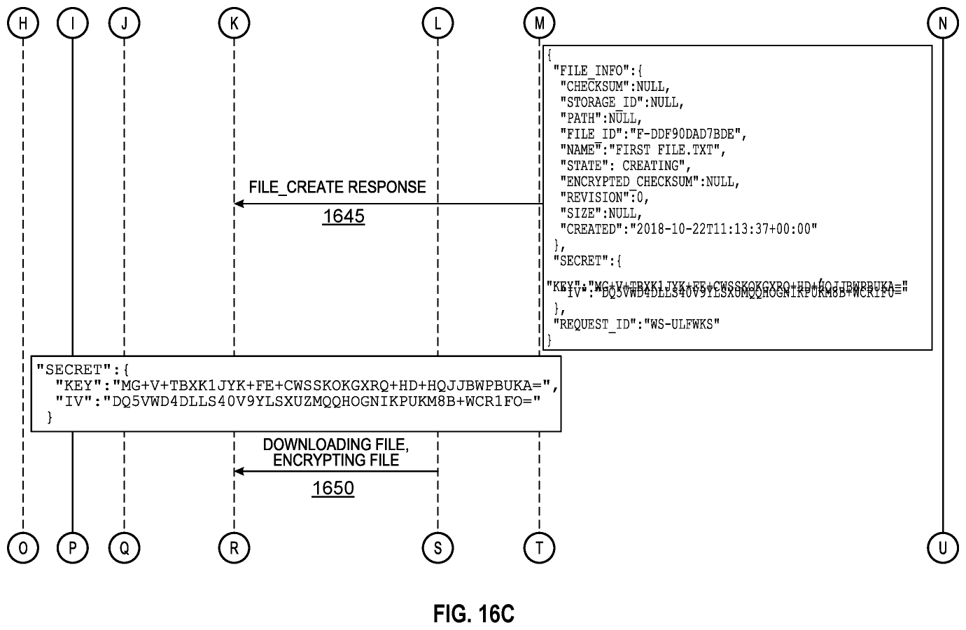

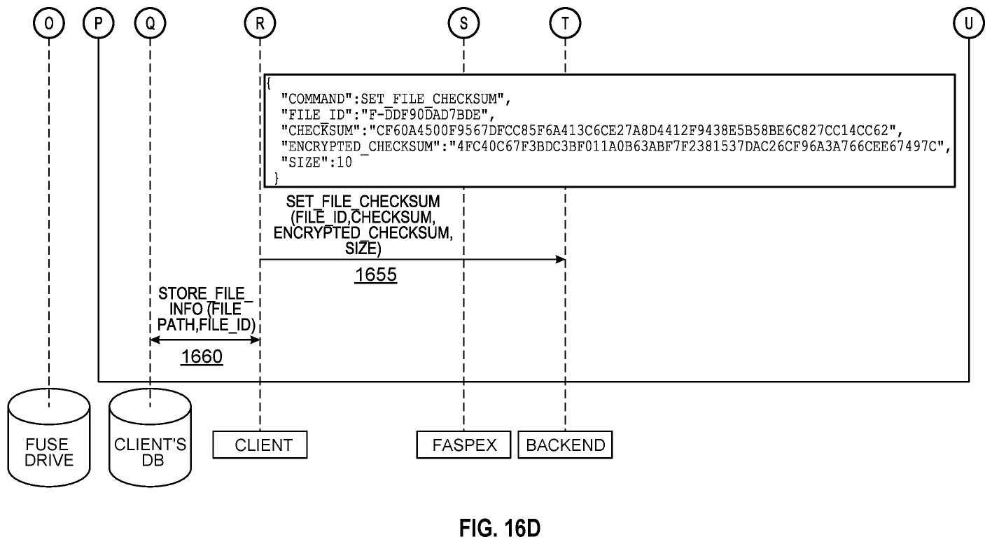

FIGS. 16A, 16B, 16C and 16D show an example of a process for downloading a file according to aspects of the present disclosure. In some examples, these operations may be performed by a system including a processor executing a set of codes to control functional elements of an apparatus. Additionally, or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

According to FIG. 16A, at operation 1600, the client downloads a file (e.g., from a file transport or storage service). At operation 1605, the client transmits a file request to a backend server.

At operation 1610, the backend server transmits file response to the client. At operation 1615, the file transport service calculates the checksum and the client downloads a file.

According to FIG. 16B, at operation 1620 the client transmits a request for a file secret from the backend server. At operation 1625, the backend server transmits a file secret response to the client.

At operation 1630, the client stores the file on a client database. At operation 1635, the client decrypts the file. At operation 1640, the client transmits a create file request to the backend server.

According to FIG. 16C, at operation 1645 the backend server transmits a create file response to the client. At operation 1650, the client downloads a file from the file transport or storage service.

According to FIG. 16D, at operation 1655 the client transmits a checksum message to the backend server. At operation 1660, the client stores the file in a client database.

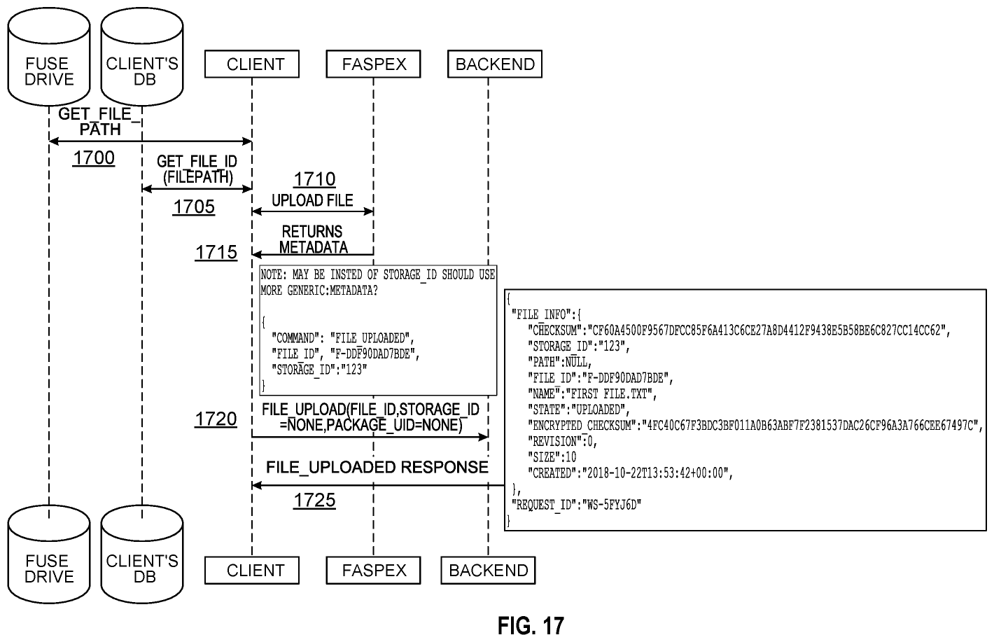

FIG. 17 shows an example of a process for uploading a file according to aspects of the present disclosure. In some examples, these operations may be performed by a system including a processor executing a set of codes to control functional elements of an apparatus. Additionally, or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At operation 1700, the client gets a file path from a FUSE drive. At operation 1705, the client retrieves a file ID from a client database.

At operation 1710, the client uploads the file to a file transport service. At operation 1715, the file transport service returns the file metadata to the client.

At operation 1720, the client transmits a file upload message to the backend server. At operation 1725, the backend server transmits a file upload response to the client.

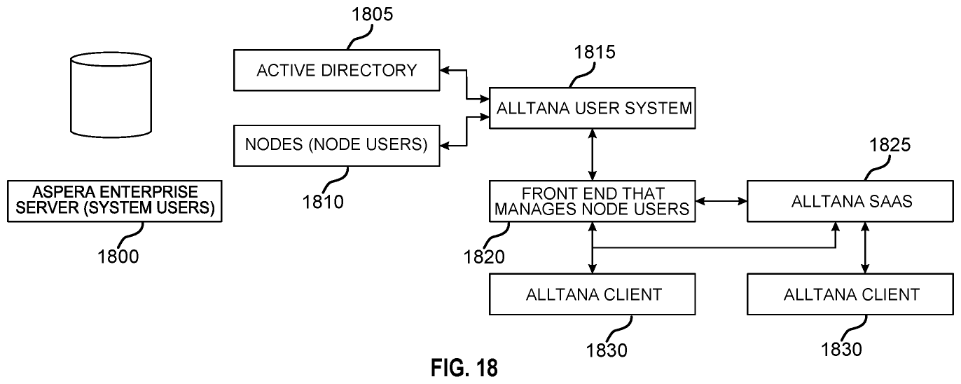

FIG. 18 shows an example of a file administration system according to aspects of the present disclosure. The example shown includes enterprise server (ES) 1800, active directory 1805, nodes 1810, user system 1815, front end 1820, SAAS application 1825, and client 1830.

In some cases, customers have workflows that send files between ES to ES; ES to P2P or P2P to P2P; P2P to ES. Customers leveraging the server to server communication present a challenge in the present embodiment because the use case heavily depends on user model created by apps like Faspex, AoC, Box, Dropbox.

In some cases, a system may track usage of an asset's progress in another organization. When a package/file was sent to another organization, on a per-package basis/per subscription basis, users can send out emails/requests asking for that asset to be trackable.

User roles may be determined within an Admin Portal so that not all users have the ability to do global administration. Possible roles may include a Global admin, a Subscription admin, a Reporting admin, and a File admin.

In one application a content provider may send a file to a post-production facility via an Aspera or Faspex server. A user downloads the file from a content provider and then takes the file into the post-production facility's private network environment. A new key will be encrypted and it will be in the post-production facility. The post-production facility will then track it and this data will also be inherited from the content provider who will also be allowed to track it as a derivative work of the original file. The post-production facility may give consent for the derivative work to be tracked. This further creates a hierarchy of the parent file and its children that is to be tracked in the backend system.

Further protection on the file may include: prompting by a password, mapping (e.g., a user can only access via a particular application), mapping a user to a computer; prompting for user credentials, using a USB key or dongle for authentication, using a machine ID to go through an authorization process, and mapping between users and folders.

In another embodiment a Media Asset Management (MAM) system or Digital Assessment Management (DAM) system can be utilized to store and manage the content. To improve the security of the assets in the MAM or DAM they can be stored in an encrypted format. The content can be stored encrypted or decrypted. The MAM or DAM can make the file available for preview by a user, if necessary, through a process of moving or copying the asset to an input folder and then moving or accessing the file at the output folder that has been decrypted allowing for conversion for a preview, or allowing access to the output folder for streaming of a preview converted file directly.

Another option is to utilize an API to transfer the file into a local processing server for transfer into the server and receiving a decrypted file if needed. This could also be used for holding an asset encrypted and they later send it out to another destination. The file could either be re-encrypted or sent in the original encrypted form allowing for continued tracking and control of rights as needed. A similar process can be utilized by a MAM or DAM to encrypted new content as well. Unencrypted content that is received can be moved into an input folder and then retrieved by the MAM or DAM for storage in an encrypted format.

In another embodiment, the hash of the file can be used to determine if a file has been modified. When assets are tracked in a directory, a file can still be tracked along with the version lineage of the different hash values to relate back to the original file. If the file has been modified it can also be re-encrypted and sent back to the original source. The database can also store the hash values of the subsequent modifications to the file.

In other embodiments, in a second computer system, the second computer system comprising the second encryption system, wherein the second encryption system re-encrypts the data file after the data file is modified, and transmits a re-encrypted data file through the data communications network; and the first computer system, the first computer system comprising the first encryption system, wherein the first encryption system decrypts the re-encrypted data file after the re-encrypted data file is written to the first virtual read directory, making the re-encrypted data file having been decrypted available on the first input directory.

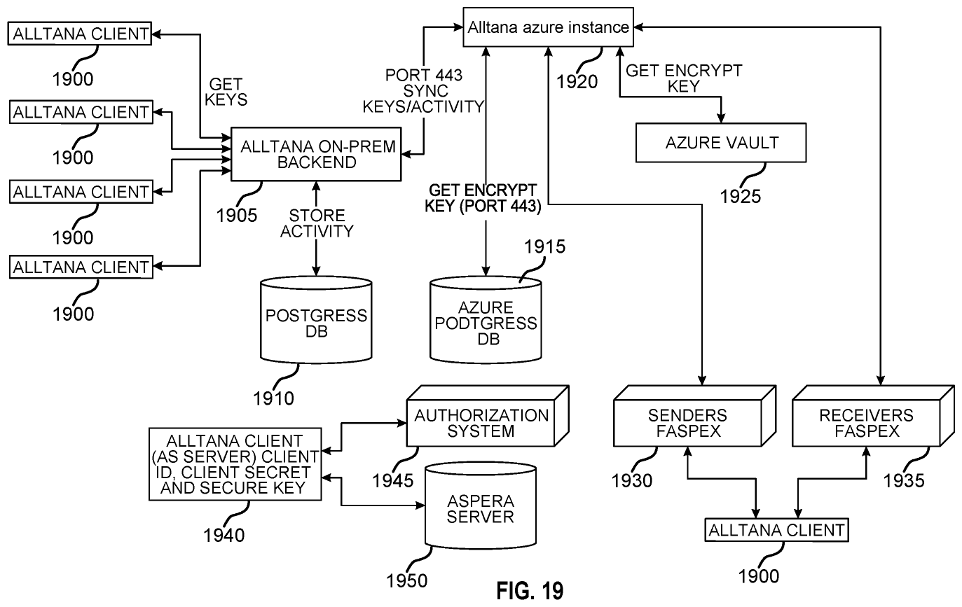

FIG. 19 shows an example of file administration system according to aspects of the present disclosure. The example shown shows the relationships between client 1900, backend 1905, Postgress database 1910, Azure database 1915, azure instance 1920, Azure vault 1925, sender Faspex 1930, receiver Faspex 1935, client server 1940, authorization system 1945, and Aspera server 1950.

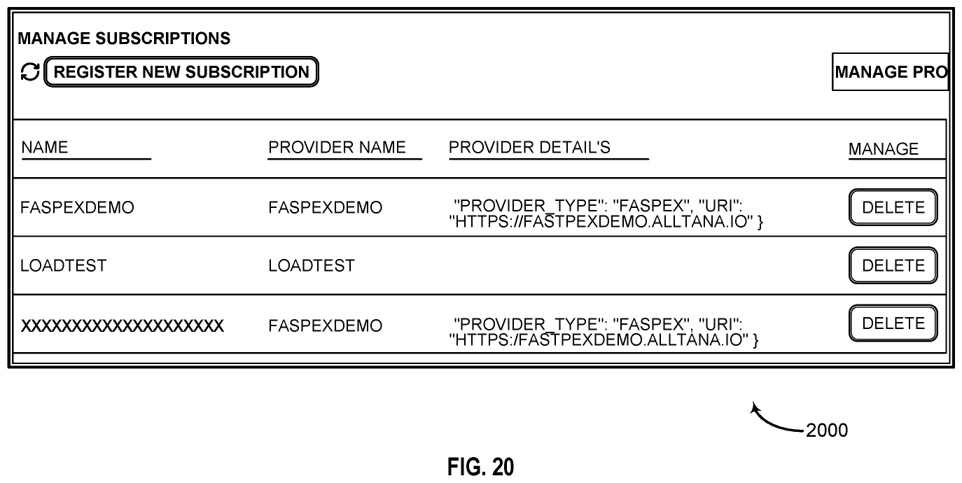

FIG. 20 shows an example of a subscription management interface 2000 according to aspects of the present disclosure. As described above, the subscription management interface 2000 may be used to manage subscriptions associated with an organization, a file transport service, and one or more users. For example, the subscription management interface 2000 may be used to register a new subscription.

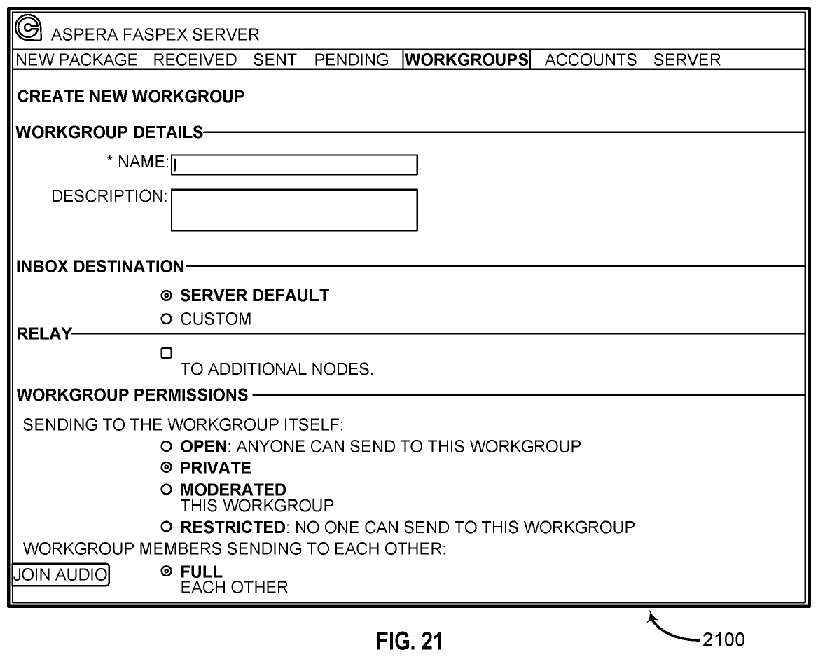

FIG. 21 shows an example of a workgroup interface 2100 according to aspects of the present disclosure. The workgroup interface 2100 may be used to input workgroup details, set an inbox destination, change relay settings, or set workgroup permissions.

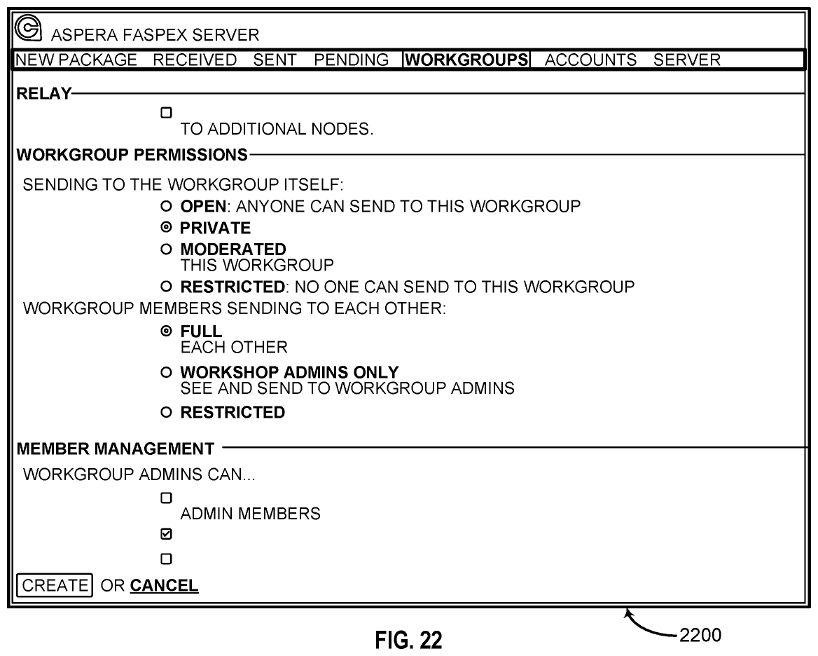

FIG. 22 shows an example of a workgroup interface 2200 according to aspects of the present disclosure. The workgroup interface 2200 shows an additional view of the workgroup interface 2100 described with reference to FIG. 21. The workgroup relay interface 2200 enables managing relay settings, managing workgroup permissions, and managing workgroup members.

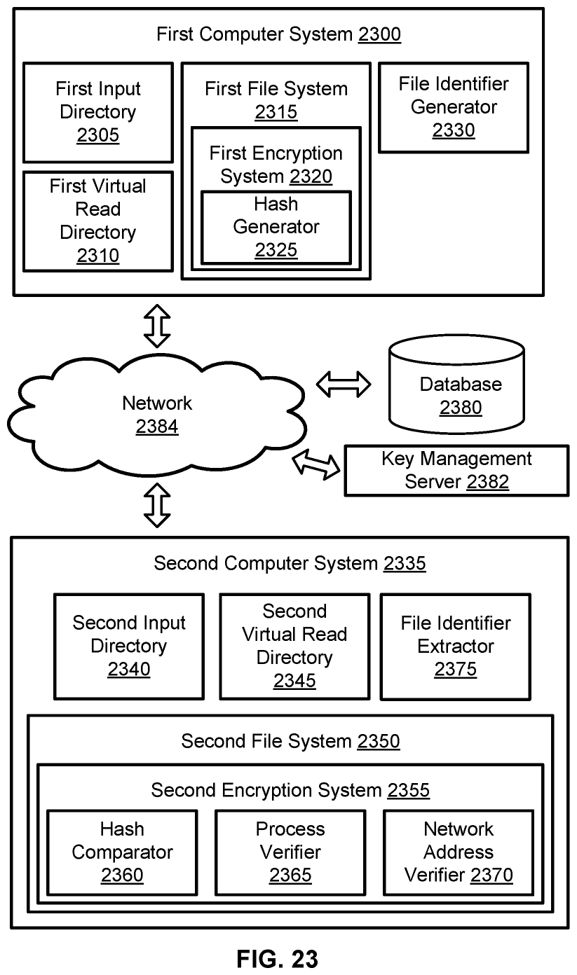

FIG. 23 shows an example of a system for distributing encrypted data files according to aspects of the present disclosure. The example shown includes first computer system 2300, second computer system 2335, database 2380, key management server 2382, and network 2384. The first computer system 2300 and second computer system 2335 may include a client as described above.

First computer system 2300 may include a first input directory 2305 and a first virtual read directory 2310, the first computer system 2300 further comprising a first file system 2315 comprising a first encryption system 2320 for encrypting a data file stored to the first input directory 2305 upon access of the data file from the first virtual read directory 2310.

In some examples, the first computer system 2300 generates a file descriptor for the data file. In some examples, the first computer system 2300 modifies the data file by adding the file descriptor to the data file after the data file is encrypted.

In some examples, the first computer system 2300 generates the file descriptor for the data file, where the file descriptor is a hash. In some examples, the first computer system 2300 generates the file descriptor for the data file, where in the file descriptor includes a unique identifier associated with a target user or an application identifier for a target application. In some cases, the file descriptor includes a unique identifier associated with the data file or with a subscription. In some examples, the file descriptor includes a unique identifier associated with an organization associated with the data file.

In some examples, the first encryption system 2320 decrypts the re-encrypted data file after the re-encrypted data file is written to the first virtual read directory 2310, making the re-encrypted data file having been decrypted available on the first input directory 2305. In some examples, the first computer system 2300 sends an encryption key through the data communications network 2384 to the second computer system 2335 in response to receipt of the hash. In some examples, the second computer system 2335 sends a unique identifier associated with a target user through the data communications network 2384 to the first computer system 2300.

In some examples, the first computer system 2300 sends an encryption key through the data communications network 2384 to the second computer system 2335 in response to receipt of a unique identifier. In some examples, the first computer system 2300 sends the encryption key through the data communications network 2384 to the second computer system 2335 in response to receipt of the unique identifier and the hash.

In some examples, the first computer system 2300 sends an encryption key through the data communications network 2384 to the second computer system 2335 in response to receipt of the file identifier. In some examples, the first computer system 2300 includes a hash generator 2325 coupled to the first computer system 2300, the hash generator 2325 generating a hash of the data file after the data file is encrypted.

In some examples, the data file stored to the first input directory 2305 upon access of the data file from the first virtual read directory 2310 is encrypted as the data file is being read from the first virtual read directory 2310.

In some examples, the first computer system 2300 includes a file identifier generator 2330, the file identifier generator 2330 generating a file identifier of the data file and placing the file identifier of the data file in the data file after the data file is encrypted. In some examples, the first computer system 2300 generates a file descriptor for the data file. In some examples, the first computer system 2300 modifies the data file by adding the file descriptor to the data file after the data file is encrypted.

In some examples, the first computer system 2300 generates the file descriptor for the data file, where the file descriptor is a hash. In some examples, the first computer system 2300 generates the file descriptor for the data file, where in the file descriptor includes a unique identifier associated with a target user.

In some examples, the first computer system 2300 generates the file descriptor for the data file, where the file descriptor is associated with an application identifier for a target application. In some examples, the first computer system 2300 generates the file descriptor for the data file, where in the file descriptor includes a unique identifier associated with the data file.

In some examples, the first computer system 2300 generates the file descriptor for the data file, where in the file descriptor includes a unique identifier associated with a subscription. In some examples, the first computer system 2300 generates the file descriptor for the data file, where in the file descriptor includes a unique identifier associated with an organization associated with the data file.

In certain embodiments, the first computer system 2300 may transmit the encrypted data file across a data communications network 2384. First computer system 2300 may also write the re-encrypted data file to the first virtual read directory 2310. First computer system 2300 may also make the re-encrypted data file having been decrypted available on the first input directory 2305. First computer system 2300 may include first input directory 2305, first virtual read directory 2310, first file system 2315, and file identifier generator 2330.

First input directory 2305 and first virtual read directory 2310 may be an example of, or include aspects of, the corresponding element or elements described with reference to FIGS. 5 and 6.

First file system 2315 may include first encryption system 2320. First encryption system 2320 may encrypt a data file stored to a first input directory 2305. First encryption system 2320 may also decrypt the re-encrypted data file. First encryption system 2320 may include hash generator 2325. Hash generator 2325 may generate a hash of the data file before the data file is encrypted.

File identifier generator 2330 may generate a file identifier. File identifier generator 2330 may also attach the file identifier to the encrypted data file.

Second computer system 2335 may be coupled to the data communications network 2384, the second computer system 2335 further comprising a second encryption system 2355 for decrypting the data file. In some examples, the second computer system 2335 includes a second storage system including a second input directory 2340 and a second virtual read directory 2345. In some examples, the second computer system 2335 further includes a second file system 2350 including the second encryption system 2355 for decrypting the data file upon access of the data file from the second virtual read directory 2345.

In some examples, the second computer system 2335 includes the second encryption system 2355 for decrypting the data file upon receipt of the data file from the data communications network 2384. In some examples, the second computer system 2335 includes a second file system 2350 for storing the data file having been decrypted.

In some examples, the second computer system 2335 receives a hash. In some examples, the second encryption system 2355 decrypts the data file only when the data file is accessed by the target application. In some examples, the second encryption system 2355 decrypts the data file upon receipt of the data file from the data communications network 2384.

In some examples, the second encryption system 2355 re-encrypts the data file after the data file is modified, and transmits a re-encrypted data file through the data communications network 2384. In some examples, the second computer system 2335 includes a hash generator 2325 generating a hash of the data file before the data file is decrypted. In some examples, the second computer system 2335 sends the hash through the data communications network 2384 to the first computer system 2300.

In some examples, the second computer system 2335 extracts a file identifier from the data file before the data file is decrypted. In some examples, the second computer system 2335 sends the file identifier through the data communications network 2384 to the first computer system 2300. In some examples, the second computer system 2335 is coupled to the key management server 2382.

In some cases, the second computer system 2335 includes a hash verifier, the hash verifier generating the hash of the data file having been received, the second computer system 2335 retrieving the encryption key from the database 2380 by submitting the hash having been generated by the hash verifier, and the database 2380 matching the hash having been generated by the hash verifier to the hash having been generated by the hash generator 2325.

In some examples, the second computer system 2335 sends a unique identifier associated with a target user through the data communications network 2384 to the first computer system 2300.

In some examples, the second computer system 2335 includes a file identifier extractor 2375, and the second computer system 2335 retrieves the encryption key from the database 2380 by submitting the file identifier having been extracted by the file identifier extractor 2375, and the database 2380 matching the file identifier having been extracted by the file identifier extractor 2375 to the file identifier having been previously generated.

In some examples, the second encryption system 2355 decrypts the data file only when the data file is accessed by a target application. In some examples, the second encryption system 2355 decrypts a data file that includes a location verifier to verify a location accessing the data file to read is allowed. In some examples, the second computer system 2335 further includes a network address verifier 2370 to check if a network 2384 address accessing the data file is not allowed to access the data file and prevents the system from decrypting the data file if the system is not allowed to access the data file.

In some examples, the second encryption system 2355 further includes a network address verifier 2370 to check if a network 2384 address accessing the data file is not allowed to access the data file and prevents the system from decrypting the data file if the system is not allowed to access the data file.

Thus, the second computer system 2335 may receive the encrypted data file. Second computer system 2335 may also transmit the re-encrypted data file through the data communications network 2384. Second computer system 2335 may include second input directory 2340, second virtual read directory 2345, second file system 2350, and file identifier extractor 2375.

Second input directory 2340 and second virtual read directory 2345 may be an example of, or include aspects of, the corresponding element or elements described with reference to FIG. 5.

Second file system 2350 may include second encryption system 2355. Second encryption system 2355 may include hash comparator 2360, process verifier 2365, and network address verifier 2370. In some examples, a process verifier 2365 may verify a process accessing the data file to read is allowed.

Hash comparator 2360 may generate a hash of the encrypted data file. Hash comparator 2360 may generate the hash of the data file after the data file is decrypted. In some cases, the hash may be received from a database 2380. Hash comparator 2360 may compare the hash having been received with the hash having been generated to determine a match.

In some examples, the verification is performed by verifying a signature of a reading process. In some examples, the verification is performed by verifying the process is on an approved list of processes. In some examples, the approved list of processes is stored in the database 2380. In some examples, the verification is performed by verifying the process is not on a blacklist of processes. In some examples, the verification is performed by checking a local cache of previously approved processes that have accessed the data file in a specified past time period.

File identifier extractor 2375 may extract the file identifier after receiving the encrypted data file.

Database 2380 may store the hash of the data file. Database 2380 may store the encryption key used for encrypting the data file. Database 2380 may also store the encryption key used for re-encrypting the data file. Database 2380 may also store an encryption key indexed to the file identifier.

In some examples, the database 2380 stores the encryption key and a recipient, where the recipient is associated with the encryption key. In some examples, the database 2380 includes a distributed ledger stored in a peer-to-peer distributed network. In some examples, the database 2380 includes a block chain. In some cases, database 2380 may match the extracted file identifier to the file identifier attached to the encrypted data file.

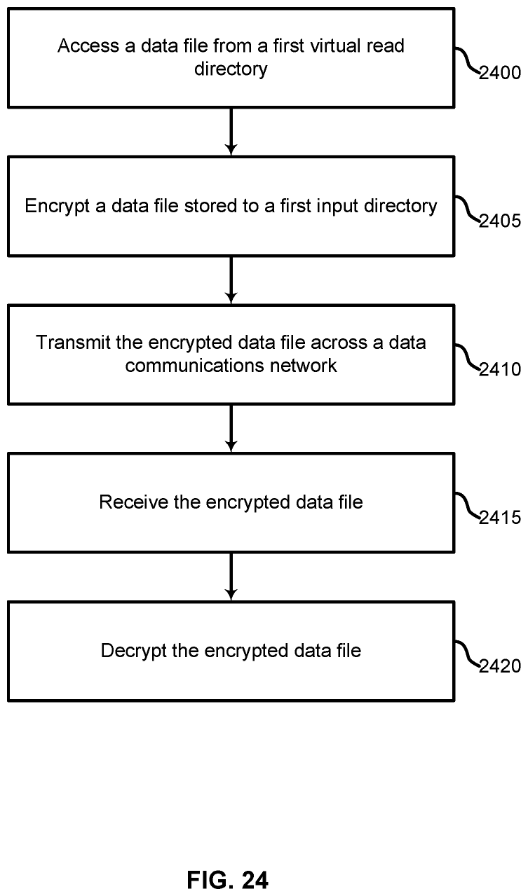

FIG. 24 shows an example of a process for data distribution based on encryption according to aspects of the present disclosure. In some examples, these operations may be performed by a system including a processor executing a set of codes to control functional elements of an apparatus. Additionally, or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At operation 2400, the system accesses a data file from a first virtual read directory. In some cases, the operations of this step may be performed by a first virtual read directory as described with reference to FIGS. 5, 6, and 23.

At operation 2405, the system encrypts a data file stored to a first input directory. In some cases, the operations of this step may be performed by a first encryption system as described with reference to FIG. 23.

At operation 2410, the system transmits the encrypted data file across a data communications network. In some cases, the operations of this step may be performed by a first computer system as described with reference to FIG. 23.

At operation 2415, the system receives the encrypted data file. In some cases, the operations of this step may be performed by a second computer system as described with reference to FIG. 23.

At operation 2420, the system decrypts the encrypted data file. In some cases, the operations of this step may be performed by a second encryption system as described with reference to FIG. 23.

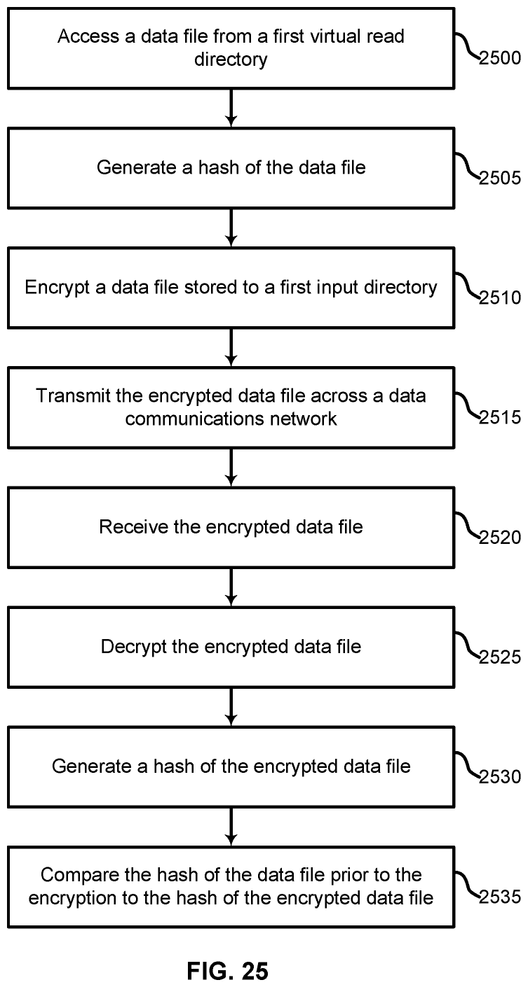

FIG. 25 shows an example of a process for data distribution based on encryption according to aspects of the present disclosure. In some examples, these operations may be performed by a system including a processor executing a set of codes to control functional elements of an apparatus. Additionally, or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At operation 2500, the system accesses a data file from a first virtual read directory. In some cases, the operations of this step may be performed by a first virtual read directory as described with reference to FIGS. 5, 6, and 23.

At operation 2505, the system generates a hash of the data file prior to the encryption. In some cases, the operations of this step may be performed by a hash generator as described with reference to FIG. 23.

At operation 2510, the system encrypts a data file stored to a first input directory. In some cases, the operations of this step may be performed by a first encryption system as described with reference to FIG. 23.

At operation 2515, the system transmits the encrypted data file across a data communications network. In some cases, the operations of this step may be performed by a first computer system as described with reference to FIG. 23.

At operation 2520, the system receives the encrypted data file. In some cases, the operations of this step may be performed by a second computer system as described with reference to FIG. 23.

At operation 2525, the system decrypts the encrypted data file. In some cases, the operations of this step may be performed by a second encryption system as described with reference to FIG. 23.

At operation 2530, the system generates a hash of the encrypted data file. In some cases, the operations of this step may be performed by a hash comparator as described with reference to FIG. 23.

At operation 2535, the system compares the hash of the data file prior to the encryption to the hash of the encrypted data file. In some cases, the operations of this step may be performed by a hash comparator as described with reference to FIG. 23.

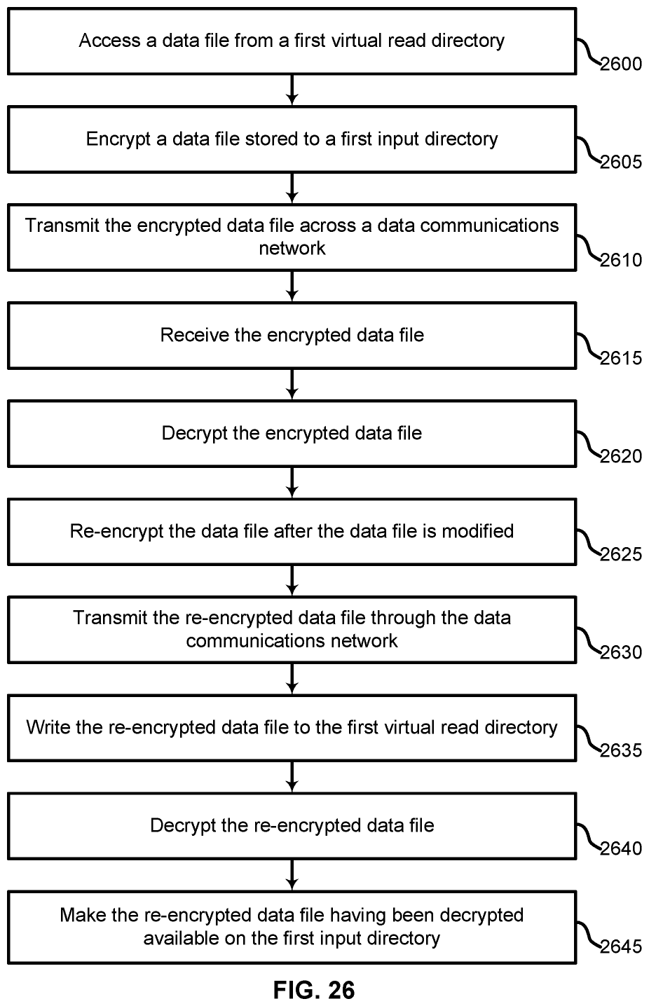

FIG. 26 shows an example of a process for data distribution based on encryption according to aspects of the present disclosure. In some examples, these operations may be performed by a system including a processor executing a set of codes to control functional elements of an apparatus. Additionally, or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At operation 2600, the system accesses a data file from a first virtual read directory. In some cases, the operations of this step may be performed by a first virtual read directory as described with reference to FIGS. 5, 6, and 23.

At operation 2605, the system encrypts a data file stored to a first input directory. In some cases, the operations of this step may be performed by a first encryption system as described with reference to FIG. 23.

At operation 2610, the system transmits the encrypted data file across a data communications network. In some cases, the operations of this step may be performed by a first computer system as described with reference to FIG. 23.

At operation 2615, the system receives the encrypted data file. In some cases, the operations of this step may be performed by a second computer system as described with reference to FIG. 23.

At operation 2620, the system decrypts the encrypted data file. In some cases, the operations of this step may be performed by a second encryption system as described with reference to FIG. 23.

At operation 2625, the system re-encrypts the data file after the data file is modified. In some cases, the operations of this step may be performed by a second encryption system as described with reference to FIG. 23.

At operation 2630, the system transmits the re-encrypted data file through the data communications network. In some cases, the operations of this step may be performed by a second computer system as described with reference to FIG. 23.

At operation 2635, the system writes the re-encrypted data file to the first virtual read directory. In some cases, the operations of this step may be performed by a first computer system as described with reference to FIG. 23.

At operation 2640, the system decrypts the re-encrypted data file. In some cases, the operations of this step may be performed by a first encryption system as described with reference to FIG. 23.

At operation 2645, the system makes the re-encrypted data file having been decrypted available on the first input directory. In some cases, the operations of this step may be performed by a first computer system as described with reference to FIG. 23.

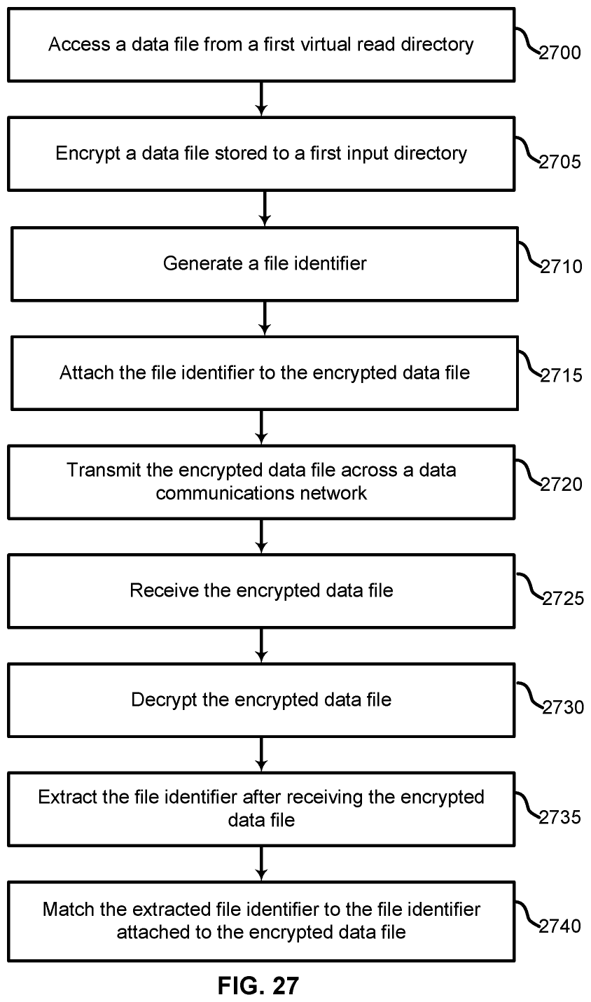

FIG. 27 shows an example of a process for data distribution based on encryption according to aspects of the present disclosure. In some examples, these operations may be performed by a system including a processor executing a set of codes to control functional elements of an apparatus. Additionally, or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At operation 2700, the system accesses a data file from a first virtual read directory. In some cases, the operations of this step may be performed by a first virtual read directory as described with reference to FIGS. 5, 6, and 23.

At operation 2705, the system encrypts a data file stored to a first input directory. In some cases, the operations of this step may be performed by a first encryption system as described with reference to FIG. 23.

At operation 2710, the system generates a file identifier. In some cases, the operations of this step may be performed by a file identifier generator as described with reference to FIG. 23.

At operation 2715, the system attaches the file identifier to the encrypted data file. In some cases, the operations of this step may be performed by a file identifier generator as described with reference to FIG. 23.

At operation 2720, the system transmits the encrypted data file across a data communications network. In some cases, the operations of this step may be performed by a first computer system as described with reference to FIG. 23.

At operation 2725, the system receives the encrypted data file. In some cases, the operations of this step may be performed by a second computer system as described with reference to FIG. 23.

At operation 2730, the system decrypts the encrypted data file. In some cases, the operations of this step may be performed by a second encryption system as described with reference to FIG. 23.

At operation 2735, the system extracts the file identifier after receiving the encrypted data file. In some cases, the operations of this step may be performed by a file identifier extractor as described with reference to FIG. 23.

At operation 2740, the system matches the extracted file identifier to the file identifier attached to the encrypted data file. In some cases, the operations of this step may be performed by a database as described with reference to FIG. 23.

Accordingly, the present disclosure includes the following embodiments.

A system for data distribution based on encryption is described. Embodiments of the system may include a first computer system comprising a first storage system comprising a first input directory and a first virtual read directory, the first computer system further comprising a first file system comprising a first encryption system for encrypting a data file stored to the first input directory upon access of the data file from the first virtual read directory, a data communications network for communicating the data file having been encrypted from the first computer system, and a second computer system coupled to the data communications network for receiving the data file from the data communications network, the second computer system further comprising a second encryption system for decrypting the data file.

A method of providing a communication system is described. The method may include providing a first computer system comprising a first storage system comprising a first input directory and a first virtual read directory, the first computer system further comprising a first file system comprising a first encryption system for encrypting a data file stored to the first input directory upon access of the data file from the first virtual read directory, providing a data communications network for communicating the data file having been encrypted from the first computer system, and providing a second computer system coupled to the data communications network for receiving the data file from the data communications network, the second computer system further comprising a second encryption system for decrypting the data file.

In some examples, the second computer system comprises a second storage system comprising a second input directory and a second virtual read directory. In some examples, the second computer system further comprises a second file system comprising the second encryption system for decrypting the data file upon access of the data file from the second virtual read directory.

In some examples, the second computer system comprises the second encryption system for decrypting the data file upon receipt of the data file from the data communications network. In some examples, the second computer system comprises a second file system for storing the data file having been decrypted.

Some examples of the system and method described above may further include a hash generator coupled to the first computer system, the hash generator generating a hash of the data file before the data file is encrypted.

In some examples, the second computer system receives the hash. Some examples may further include a hash comparator generating the hash of the data file after the data file is decrypted and for receiving the hash from a database, and for comparing the hash having been received with the hash having been generated to determine a match.

Some examples of the system and method described above may further include a database storing the hash of the data file. Some examples of the system and method described above may further include a database coupled to the first encryption system, the database storing an encryption key for the data file, the encryption key used for encrypting the data file.

In some examples, the first computer system generates a file descriptor for the data file. In some examples, the first computer system modifies the data file by adding the file descriptor to the data file after the data file is encrypted.

In some examples, the first computer system generates the file descriptor for the data file, wherein the file descriptor is a hash. In some examples, the first computer system generates the file descriptor for the data file, where in the file descriptor comprises a unique identifier associated with a target user.

In some examples, the first computer system generates the file descriptor for the data file, wherein the file descriptor is associated with an application identifier for a target application. In some examples, the second encryption system decrypts the data file only when the data file is accessed by the target application.

In some examples, the second computer system comprises a second storage system comprising a second input directory and a second virtual read directory, the second computer system further comprising a second file system comprising the second encryption system for decrypting the data file upon access of the data file from the second virtual read directory.

In some examples, the second encryption system decrypts the data file upon receipt of the data file from the data communications network. In some examples, the second computer system comprises a second file system for storing the data file having been decrypted.

Some examples of the system and method described above may further include a hash generator coupled to the first computer system, the hash generator generating a hash of the data file before the data file is encrypted.

In some examples, the second computer system receives the hash. Some examples may further include a hash comparator for generating the hash of the data file after the data file is decrypted and for receiving the hash from a database, and for comparing the hash having been received with the hash having been generated to determine a match.

Some examples of the system and method described above may further include a database storing the hash of the data file. Some examples of the system and method described above may further include a database coupled to the first encryption system, the database storing an encryption key for the data file, the encryption key used for encrypting the data file.

In some examples, the first computer system generates the file descriptor for the data file, wherein the file descriptor comprises a unique identifier associated with the data file. In some examples, the first computer system generates the file descriptor for the data file, wherein the file descriptor comprises a unique identifier associated with a subscription. In some examples, the first computer system generates the file descriptor for the data file, wherein the file descriptor comprises a unique identifier associated with an organization associated with the data file.

In some examples, the second encryption system re-encrypts the data file after the data file is modified, and transmits a re-encrypted data file through the data communications network. In some examples, the first encryption system decrypts the re-encrypted data file after the re-encrypted data file is written to the first virtual read directory, making the re-encrypted data file having been decrypted available on the first input directory.

Some examples of the system and method described above may further include a database coupled to the second encryption system, the database storing an encryption key for the re-encrypted data file, the encryption key used for re-encrypting the data file.

In some examples, the database stores the encryption key and a recipient, wherein the recipient is associated with the encryption key. In some examples, the database comprises a distributed ledger stored in a peer-to-peer distributed network.

In some examples, the database comprises a block chain. In some examples, the second computer system comprises a hash generator generating a hash of the data file before the data file is decrypted.

In some examples, the second computer system sends the hash through the data communications network to the first computer system. In some examples, the first computer system sends an encryption key through the data communications network to the second computer system in response to receipt of the hash.

In some examples, the second computer system sends a unique identifier associated with a target user through the data communications network to the first computer system. In some examples, the first computer system sends an encryption key through the data communications network to the second computer system in response to receipt of the unique identifier.

In some examples, the second computer system sends the hash through the data communications network to the first computer system. In some examples, the first computer system sends the encryption key through the data communications network to the second computer system in response to receipt of the unique identifier and the hash.

In some examples, the second computer system extracts a file identifier from the data file before the data file is decrypted. In some examples, the second computer system sends the file identifier through the data communications network to the first computer system. In some examples, the first computer system sends an encryption key through the data communications network to the second computer system in response to receipt of the file identifier.

Some examples of the system and method described above may further include a key management server coupled to the first computer system. In some examples, the first computer system comprises a hash generator coupled to the first computer system, the hash generator generating a hash of the data file after the data file is encrypted. Some examples may further include a database coupled to the first encryption system, the database storing an encryption key for the data file, the encryption key used for encrypting the data file, the encryption key being indexed to the hash.

In some examples, the second computer system is coupled to the key management server, the second computer system comprising a hash verifier, the hash verifier generating the hash of the data file having been received, the second computer system retrieving the encryption key from the database by submitting the hash having been generated by the hash verifier, and the database matching the hash having been generated by the hash verifier to the hash having been generated by the hash generator.

In some examples, the database comprises a distributed ledger stored in a peer-to-peer distributed network. In some examples, the database comprises a block chain.

In some examples, the data file stored to the first input directory upon access of the data file from the first virtual read directory is encrypted as the data file is being read from the first virtual read directory.

In some examples, the second computer system sends a unique identifier associated with a target user through the data communications network to the first computer system. In some examples, the first computer system sends an encryption key through the data communications network to the second computer system in response to receipt of the unique identifier.

In some examples, the second computer system sends a hash through the data communications network to the first computer system. In some examples, the first computer system sends the encryption key through the data communications network to the second computer system in response to receipt of the unique identifier and the hash.

Some examples of the system and method described above may further include a key management server coupled to the first computer system. In some examples, the first computer system comprises a file identifier generator coupled to the first computer system, the file identifier generator generating a file identifier of the data file and placing the file identifier of the data file in the data file after the data file is encrypted. Some examples may further include a database coupled to the first encryption system, the database storing an encryption key for the data file, the encryption key used for encrypting the data file, the encryption key being indexed to the file identifier.

In some examples, the second computer system is coupled to the key management server, the second computer system comprising a file identifier extractor, the second computer system retrieving the encryption key from the database by submitting the file identifier having been extracted by the file identifier extractor, and the database matching the file identifier having been extracted by the file identifier extractor to the file identifier having been previously generated.

In some examples, the second computer system comprises a second storage system comprising a second input directory and a second virtual read directory, the second computer system further comprising a second file system comprising the second encryption system for decrypting the data file upon access of the data file from the second virtual read directory.

In some examples, the second encryption system decrypts the data file upon receipt of the data file from the data communications network. In some examples, the second computer system comprises a second file system for storing the data file having been decrypted.

Some examples of the system and method described above may further include a hash generator coupled to the first computer system, the hash generator generating a hash of the data file before the data file is encrypted.

In some examples, the second computer system receives the hash. Some examples may further include a hash comparator generating the hash of the data file after the data file is decrypted and for receiving the hash from the database, and for comparing the hash having been received with the hash having been generated to determine a match.

In some examples, the database stores the hash of the data file. In some examples, the database is coupled to the first encryption system, the database storing the encryption key for the data file, and the encryption key is used for encrypting the data file.

In some examples, the database comprises a distributed ledger stored in a peer-to-peer distributed network. In some examples, the database comprises a block chain. In some examples, the second encryption system for decrypting the data file further comprises a process verifier to verify a process accessing the data file to read is allowed.

In some examples, the verification is performed by verifying a signature of a reading process. In some examples, the verification is performed by verifying the process is on an approved list of processes. In some examples, the approved list of processes is stored in the database. In some examples, the verification is performed by verifying the process is not on a blacklist of processes.

In some examples, the verificationing is performed by checking a local cache of previously approved processes that have accessed the data file in a specified past time period. Some examples of the system and method described above may further include a virtual directory, wherein the virtual directory is a virtual mount.

In some examples, the first input directory and the first virtual read directory are the same directory. In some examples, the first computer system generates a file descriptor for the data file. In some examples, the first computer system modifies the data file by adding the file descriptor to the data file after the data file is encrypted.

In some examples, the first computer system generates the file descriptor for the data file, wherein the file descriptor is a hash. In some examples, the first computer system generates the file descriptor for the data file, wherein the file descriptor comprises a unique identifier associated with a target user.

In some examples, the first computer system generates the file descriptor for the data file, wherein the file descriptor is associated with an application identifier for a target application. In some examples, the second computer system comprises the second encryption system, wherein the second encryption system decrypts the data file only when the data file is accessed by the target application.

In some examples, the first computer system generates the file descriptor for the data file, wherein the file descriptor comprises a unique identifier associated with the data file. In some examples, the first computer system generates the file descriptor for the data file, wherein the file descriptor comprises a unique identifier associated with a subscription.

In some examples, the first computer system generates the file descriptor for the data file, wherein the file descriptor comprises a unique identifier associated with an organization associated with the data file. In some examples, the second computer system further comprises the second encryption system for decrypting the data file further comprising a location verifier to verify a location accessing the data file to read is allowed.

In some examples, the second computer system further comprises the second encryption system for decrypting the data file further comprising a network address verifier to check if a network address accessing the data file is not allowed to access the data file and prevents the system from decrypting the data file if the system is not allowed to access the data file.

In some examples, the second encryption system for decrypting the data file further comprises a network address verifier to check if a network address accessing the data file is not allowed to access the data file and prevents the system from decrypting the data file if the system is not allowed to access the data file.

A method for data distribution based on encryption is described. Embodiments of the method may include accessing a data file from a first virtual read directory, encrypting a data file stored to a first input directory, transmitting the encrypted data file across a data communications network, receiving the encrypted data file, and decrypting the encrypted data file.

An apparatus for data communication is described. The apparatus may include a processor, memory in electronic communication with the processor, and instructions stored in the memory. The instructions may be operable to cause the processor to access a data file from a first virtual read directory, encrypt a data file stored to a first input directory, transmit the encrypted data file across a data communications network, receive the encrypted data file, and decrypt the encrypted data file.

A non-transitory computer readable medium storing code for data communication is described. In some examples, the code comprises instructions executable by a processor to: access a data file from a first virtual read directory, encrypt a data file stored to a first input directory, transmit the encrypted data file across a data communications network, receive the encrypted data file, and decrypt the encrypted data file.

Some examples of the method, apparatus, and non-transitory computer readable medium described above may further include generating a hash of the data file prior to the encryption. Some examples of the method, apparatus, and non-transitory computer readable medium described above may further include generating a hash of the encrypted data file. Some examples may further include comparing the hash of the data file prior to the encryption to the hash of the encrypted data file.

Some examples of the method, apparatus, and non-transitory computer readable medium described above may further include re-encrypting the data file after the data file is modified. Some examples may further include transmitting the re-encrypted data file through the data communications network. Some examples may further include writing the re-encrypted data file to the first virtual read directory. Some examples may further include decrypting the re-encrypted data file. Some examples may further include making the re-encrypted data file having been decrypted available on the first input directory.

Some examples of the method, apparatus, and non-transitory computer readable medium described above may further include generating a file identifier. Some examples may further include attaching the file identifier to the encrypted data file. Some examples may further include extracting the file identifier after receiving the encrypted data file. Some examples may further include matching the extracted file identifier to the file identifier attached to the encrypted data file.

Some of the functional units described in this specification have been labeled as modules, or components, to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

While the invention herein disclosed has been described by means of specific embodiments, examples and applications thereof, numerous modifications and variations could be made thereto by those skilled in the art without departing from the scope of the invention set forth in the claims.

What is claimed is:

1. A system for data distribution comprising:
a first computer system comprising a first storage system comprising a first input directory and a first virtual read directory, the first computer system further comprising a first file system comprising a first encryption system for encrypting a data file stored to the first input directory upon access of the data file from the first virtual read directory;
a data communications network for communicating the data file having been encrypted from the first computer system; and
a second computer system coupled to the data communications network for receiving the data file from the data communications network, the second computer system further comprising a second encryption system for decrypting the data file.

2. The system of claim 1 further comprising:
the second computer system, the second computer system comprising a second storage system comprising a second input directory and a second virtual read directory, the second computer system further comprising a second file system comprising the second encryption system for decrypting the data file upon access of the data file from the second virtual read directory.

3. system of claim 1 further comprising:
the second computer system, the second computer system comprising the second encryption system for decrypting the data file upon receipt of the data file from the data communications network.

4. The system of claim 3 further comprising:
the second computer system, the second computer system comprising a second file system for storing the data file having been decrypted.

5. The system of claim 1 further comprising:
a key management server coupled to the first computer system;
the first computer system comprising a file identifier generator coupled to the first computer system, the file identifier generator generating a file identifier of the data file and placing the file identifier of the data file in the data file after the data file is encrypted;
a database coupled to the first encryption system, the database storing an encryption key for the data file, the encryption key used for encrypting the data file, the encryption key being indexed to the file identifier;
the second computer system coupled to the key management server, the second computer system comprising a file identifier extractor, the second computer system retrieving the encryption key from the database by submitting the file identifier having been extracted by the file identifier extractor, and the database matching the file identifier having been extracted by the file identifier extractor to the file identifier having been previously generated.

6. The system of claim 5 further comprising:
the second computer system, the second computer system comprising a second storage system comprising a second input directory and a second virtual read directory, the second computer system further comprising a second file system comprising the second encryption system for decrypting the data file upon access of the data file from the second virtual read directory.

7. The system of claim 5 further comprising:
the second computer system, the second computer system comprising the second encryption system for decrypting the data file upon receipt of the data file from the data communications network.

8. The system of claim 7 further comprising:
the second computer system, the second computer system comprising a second file system for storing the data file having been decrypted.

9. The system of claim 5 further comprising a hash generator coupled to the first computer system, the hash generator generating a hash of the data file before the data file is encrypted.

10. The system of claim 9 further comprising:
the second computer system, the second computer system receiving the hash, and further comprising a hash comparator generating the hash of the data file after the data file is decrypted and for receiving the hash from the database, and for comparing the hash having been received with the hash having been generated to determine a match.

11. The system of claim 9 further comprising storing the hash of the data file in the database.

12. The system of claim 5 further comprising:
the database coupled to the first encryption system, the database storing the encryption key for the data file, the encryption key used for encrypting the data file.

13. The system of claim 12 further comprising:
the database, wherein the database comprises a distributed ledger.

14. The system of claim 5 further comprising:
the second computer system further comprising the second encryption system for decrypting the data file further comprising a process verifier to verify a process accessing the data file to read is allowed.

15. The system of claim 14 wherein a verification is performed by verifying a signature of a reading process.

16. The system of claim 5 further comprising a virtual directory, wherein the virtual directory is a virtual mount.

17. The system of claim 5 wherein the first input directory and the first virtual read directory are the same directory.

18. The system of claim 5 further comprising:
the first computer system, the first computer system generating a file descriptor for the data file.

19. The system of claim 18 further comprising:
the first computer system, the first computer system modifying the data file by adding the file descriptor to the data file after the data file is encrypted.

20. The system of claim 18 further comprising:
the first computer system, the first computer system generating the file descriptor for the data file, where in the file descriptor comprises a unique identifier associated with a target user.

21. The system of claim 20 further comprising:
the second computer system, the second computer system comprising the second encryption system, wherein the second encryption system decrypts the data file only when the data file is accessed by a target application.

22. The system of claim 18 further comprising:
the first computer system, the first computer system generating the file descriptor for the data file, where in the file descriptor comprises a unique identifier associated with the data file.

23. The system of claim 18 further comprising:
the second computer system further comprising the second encryption system for decrypting the data file further comprising a location verifier to verify a location accessing the data file to read is allowed.

24. The system of claim 1 further comprising:
the second computer system further comprising the second encryption system for decrypting the data file further comprising a network address verifier to verify a network address accessing the data file to read is allowed.
